(19) United States
(12) Patent Application Publication
(10) Pub. No.: US 2011/0250939 A1
(43) Pub. Date: Oct. 13, 2011

(54) NETWORK-CONNECTED GOLF GAME IMPROVEMENT, ENTERTAINMENT AND MONETIZATION SYSTEM AND METHOD

(76) Inventor: Marc L. Hobler, Rochester, NY (US)

(21) Appl. No.: 13/081,383

(22) Filed: Apr. 6, 2011

Related U.S. Application Data
(60) Provisional application No. 61/322,437, filed on Apr. 9, 2010.

(51) Int. Cl. A63F 13/00; G06F 19/00; A63F 9/24

(52) U.S. Cl. 463/7; 463/42; 700/91

(57) ABSTRACT

A network-connected golf game improvement and entertainment system and methods that connect golf simulators in a plurality of golf sites or residences into an interactive player network. The player network facilitates the context of interaction between players, spectators and adversities. The system and method further include an on-line marketplace that enables advertisers to purchase and place interactive advertising into specific experience channels in real-time. Advertisers would have a direct and real-time channel into their ads analytics, performance and automated financial transaction processing.

Priority is claimed from U.S. Provisional Application No. 61/322,437 by M. Nobler, for a “NETWORK-CONNECTED GOLF GAME IMPROVEMENT, ENTERTAINMENT AND MONETIZATION SYSTEM AND METHOD,” filed Apr. 9, 2010, which is hereby incorporated by reference in its entirety.

The disclosed system and method enables the systematic manipulation, transmission and collaboration of specific performance metrics derived from and in accordance with the physical skill of a player, or group of players, in the execution of a simulated sporting event, where the event construct is defined, initiated and executed by the player or players. The disclosed system and method also enables the systematic analysis, bidding, acquisition and execution of relevant advertisement placed dynamically into specific channels within the experience of one or more players, enabling the advertiser to more proactively manage the effectiveness of their sports advertisement initiatives.

For example, the disclosed system and methods are particularly applicable to golf and facilitate improvements in a user's performance in golf through personal, social or competitive virtual golf entertainment venues. More specifically, the system employs golf simulators that are inter-connected and available to a group of users via networked or web-based applications (e.g., Web 2.0). The system and associated methods provide a common entertainment platform for golfers to improve their game by enabling a self-service environment where the players control the play venue, format, invitees, rules and timing of personal, social and competitive events in and around golf simulator play and independent of time and location (e.g., playing on a preferred course, format, rules and asynchronously over a period of time). The disclosed system also enables a player to analyze and discover key performance insights and trends into their game, and other players in the network, over time. Simultaneously, golf advertisers may be bidding and competing for the most relevant player advertisement channels.

### BACKGROUND AND SUMMARY

Golf is arguably one of the most challenging and demanding games to learn and maintain, much less improve. Market research shows year after year that new and existing golfers would play more golf if they could play better, if it was less intimidating and more time and cost effective. The pace of life is just too fast with too little time. As a result, golfers are looking for new ways to escape that move from “big gulps” or day-long indulgences to “small bites” or short-formatted fun, particularly in game improvement. Ultimately, the disclosed embodiment, referred to herein as LinksPlay^{SM} or alternatively PlayerNet^{SM}, provides a revolutionary method making game improvement more fun, affordable and practical, and in the process unlocking the game for millions of new and existing golfers. LinksPlay^{SM} is the first known interactive player network where virtual play translates into better physical play. Aspects of the disclosed systems and methods provide a new form of human augmentation, where the Internet keeps the player or spectator continuously connected to not only their own game, but the social and competitive connections to their game.

Golf courses tend to be geographically inaccessible, subject to use limitations (seasonal, weather, lack of light, etc) and time and cost prohibitive option for game improvement. In addition, golf course revenue through green fees is based entirely on golfer throughput, or moving as many golfers through the course as rapidly possible, a business model that is diametrically opposed to game improvement. Driving ranges, while certainly more time and cost effective as a game improvement option, lack the look, feel and situational awareness of course play and offer little if any player performance feedback that is so critical to game improvement.

One way of alleviating these challenges has been through the use of golf simulators because they permit indoor use, not subject to climate and weather conditions and provide virtual play scenarios that take half the time of similar physical play scenarios. In addition, simulators allow players to both practice and play golf as it fits their schedule and at their own pace as they strive to improve their skills by means of performance feedback from various sensing technologies.

The embodiment disclosed herein utilize golf simulators or other simulation means for a player to practice various golf swing and putting skills, as well as to virtually play on a pre-selected, video-projected golf course. In most simulators, the user's performance is determined based upon some means of tracking a golf ball at launch, measuring or calculating the golf ball trajectory and subsequently calculating and rendering the projected flight and landing position of the ball as a displayed icon. A golf simulator typically comprises a screen on which an image of a segment of a golf course is depicted, where the ball is driven or hit into the projection screen, and uses radar or vision-based tracking technology to detect one or more of the following attributes: impact of a club on the golf ball, the trajectory of the ball, rotation of the ball, the arc of the golf club head throughout the swing, etc. For example, in the AboutGolf® simulators (aboutGolf, Ltd., Maumee, Ohio) a technology called 3Track™ uses at least a three-dimensional, high-speed photographic tracking system to measure all three dimensions of spin, including both spin and spin axis. Since all three dimensions play a role in shot behavior and performance, simulator technology can replicate true course play. Based upon such performance information, a pre-programmed computing system processes the sensor data to project the position of the ball by calculating its velocity, bounce and roll in accordance with the topography of hole being played. Moreover, the computing system associated with the simulator, as further described herein, can be integrated with a larger network to provide various options for users, spectators, vendors, advertisers, etc.

Throughout their development, golf simulators have dramatically increased in the level of technology employed, and thus realism, as evolving simulation engines and tracking technologies are integrated to more accurately reflect the characteristics of the real world environment being simulated. Attributes that may be incorporated into simulator play include: time of day, environmental factors such as rain, shadows, wind strength/direction; ball spin, lift and drag coefficients and the like, each of which can now be monitored and simulated, and thereby made suitable for skill development of the player. However, as precise and realistic as they might be, golf simulators have traditionally been designed as golf performance analysis tools, specifically to support golf instruction and club-fitting scenarios, with a secondary focus on entertainment if at all. Golf simulators alone are incapable of creating an entertainment environment that enables the player to control their social or competitive interactivity between themselves and other players independent of time and location. In other words, while a simulator may “simulate” one's performance, it typically does not facilitate social and competitive interactions that encourage golfers to play more frequently and is thus a primary impediment to the use of simulators as a mainstream game improvement and entertainment alternative in the U.S.

Another drawback of the use of golf simulators as stand-alone devices is that while they are increasingly able to accurately simulate a golfer's play, the data available after play for player analysis is generally limited to basic player scores and statistics of the last player session if at all. On the other hand, simulators generate rich club, ball and shot data after each and every swing. Unfortunately, such information is of little value unless there are systems and methods by which the information may be captured, stored and accessed before and after play, enabling the player to analyze and discover key performance insights and trends as their game evolves over time. And, such information needs to be collected automatically, meaning limited or no user entry of data, in order to avoid problems of accuracy, errors, etc. when the user inputs such information, a problem that plagues manual golf performance data collection and analysis tools today. In addition, each of the golf simulators need to be automatically configured to assure play uniformity and consistency from one player to the next, critical in building player trust and confidence in the data. In other words, while a simulator may “simulate” one's performance, it typically does not deliver the core capabilities necessary to effectively facilitate a personal interaction between the golfer and their own game that encourages the golfer to play more frequently and thus is a significant impediment to the use of simulators as a mainstream game improvement and entertainment alternative in the U.S. Providing the ability to capture, store and access such data, for various purposes, is one aspect of the methods and system disclosed herein.

Using the data automatically collected by simulators, which is highly accurate and complete, users of the system will also be able to analyze their performance, trends, etc. However, the system will not be limited to merely looking at data in a format someone else has determined. Rather, the system will permit the interactive and dynamic use of data when performing logical analysis, i.e., analytics, and thereby permit a golfer or other user to view and process data in a manner that they are able to control. For example, if a player wanted to determine the frequency of use of the irons in their bag, they could construct a data view based upon their simulator play to depict the use levels of each iron in say a bar graph. The information gathered by, stored and processed or analyzed by the system includes data related to golfer scoring, performance and leader analysis, trending and tracking, etc. The stored information also presents further opportunities. Referred to herein as “player informatics” the data that is collected and stored may also be employed in one or several monetization approaches wherein the data itself is the basis for compensation; the data is used to seed or drive uses resulting in compensation, etc. As will be further described below, several approaches to monetization use or are associated with the data and information that is stored and analyzed by the disclosed system and methods.

Accordingly, the disclosed embodiments are intended to improve a golfer's experience by expanding on the existing capabilities of golf simulators and to include remote access to and combination of simulator-derived data and player-controlled personal, social and competitive data for the purpose of facilitating better interaction between the player and their own game and with other players. More specifically, the discussed embodiments will provide an ability to design, initiate and execute personal, social or competitive event (e.g., personal round, group skills contest or group tournament) that is managed by each, or any one, of the players, whereby a winner may be identified and recognized accordingly. Additionally, events provide a rich context around the golfer's performance data, providing insights into how the player performed during private, public or even sponsored events. For example, in one monetization method contemplated by the disclosed system and methods, an event can be sponsored by an advertiser where rich, contextual ads are seamlessly integrated into the experience of the event for all players, which in turn increases not only brand and product awareness, but the effectiveness of the overall advertisement campaign.

In the interest of facilitating personal, social and competitive interactivity amongst golfers using the simulator golf community at large, the disclosed system is intended to take advantage of the Internet and Web 2.0 features that enable cloud based applications and thereby facilitate interactive information sharing, interoperability, user-centric formats, monetization and group collaboration sessions anywhere, anytime and on any device. Web 2.0 is a world where “users create value” when they passively or actively contribute to a topic in an on-line community, when they interact with devices or sensors and the data captured provides feedback for continuous improvement, when they express themselves to show their excitement about a particular passion or when they make a new on-line contact that becomes the multiplicative expansion of the social graph, or people network interconnections. And like many of the most successful Web 2.0 concepts, the greater the player usage, the greater the player value. Put differently, the more the player plays, the richer the performance insights and trends surfaced back to the player for analysis. In addition, the greater the player network size, the greater the value multiplicative for every player. In other words, for each new indoor golf center or indoor golf café, a new set of on-line players and communities become instantly integrated into the player network, creating a continuous compounding effect. The personal, competitive and social network interactivity will create the environmental conditions for viral growth.

As will be described in greater detail below, one embodiment contemplates the use of a system having a plurality of golf simulators providing virtual events (driving range, single user play, lessons, course play, group play, tournaments and similar competition, etc.), used by a number of golfers wherein the golfers may have access to their own, and possibly others', performance information. The information may be accessed via simulators themselves, via an on-line connection such as a web browser (e.g., at a indoor golf center, café or at a user's home or office, etc.), and possibly via handheld devices running “applications” that may be employed during actual physical golf play. All of these means of accessing the system provide for the interaction and exchange of information relative to the golfer's game improvement experience.

Several embodiments disclosed herein contemplate a system that is based upon users that include players (golfers that play virtual golf in the network), spectators (users that view the network action anywhere on the Internet), advertisers (businesses that place ads in the network) and administrators (users that can administer and manage the system) that may wish to access the system. For example, as depicted in FIG. 4, players are able to uniquely define, initiate and execute completely new events that can represent every possible single player and multi-player golf simulator play scenario from the simplest to the most complex, with constructs that assure uniformity and consistency of play between participants independent of time and location. The player can define the venue including creating a custom course, the format, the rules, the invitees and the timeframe. Or the player can simply select an existing event for play. And the more the player plays, the richer the insights and performance trends to their game through “Player Informatics”. Spectators, or anyone on the Internet, have a real-time channel into the player interaction, creating the viral effect for future customers, franchisees, investors, suppliers and partners. And it is the Player interaction that sets the foundation for a set of monetization methods that facilitates the context for interaction between the Advertiser and the Player through an open internet marketplace where the Advertiser can bid and secure ads within specific slices of the Player's or Spectator's internet experience. Lastly, the Administrators are responsible for effectively managing the system the lies between the Players, Spectators and Advertisers.

An object of the disclosed embodiments is to provide interactive player informatics, leader boards, events and forums around golf simulator sessions locally, regionally, and/or globally.

A further object of the disclosed embodiments is to capture and control player profiles and performance-oriented player data for insight and leverage into future Internet product and service investments.

Another object of the disclosed embodiments is to optimize on-line user-initiated features while reducing site implementation, specifically on-site staff facilitating player events versus an automated system, and the on-going operational support costs as a result

A further objective is to enrich the social and competitive dynamic to promote better client retention rates, session frequency and average time per session for drop-ins and memberships

In accordance with an additional object of the disclosed embodiments, group play or events could include a reward or similar remuneration means for the person(s) identified as having achieved at a particular level in an event (e.g., winning score, longest drive, most consistent performance, most holes played in a day, etc.).

Yet another object is to provide a calibration mechanism or process to ensure that all simulators used in association with the system are correlated to provide consistent results.

In accordance with another aspect of the disclosed embodiments, there is provided a means for monetization from performance data

Other and further objects, features and advantages will be evident from a reading of the following specification and by reference to the accompanying drawings forming a part thereof, wherein the examples of the presently preferred embodiments are given for the purposes of disclosure.

Disclosed in embodiments herein is a method to facilitate the acquisition and sharing of information related to a golfer, comprising: collecting and storing, in a memory associated with and accessible by a networked computer, personal information about the golfer; collecting and storing, in the memory, performance data representative of the golfer's performance in at least one event associated with a simulated golf environment wherein said data collection and storage is automated and occurs without the golfer's intervention; subsequently providing access to said memory and data to the golfer including the ability to perform at least one analysis of the golfer's performance data; and initiating, in response to a golfer's input, an event in which the golfer and/or other golfers may participate, said event operating upon or resulting in the collection of data in the memory. See FIG. 2C for an exemplary informatics architecture.

Further disclosed in embodiments herein is a system for facilitating the acquisition and sharing of information related to a golfer, comprising: a simulator for providing a simulated golf environment for at least one golfer; an application rich cloud, including at least one networked computer and associated memory that serves to enable global access to various processes, said cloud facilitating the storage of data generated by the simulator when used by the golfer; and a plurality of remote computer platforms having access to said application rich cloud, whereby the golfer accesses the data generated by the simulator and stored therein. See FIG. 2D for an exemplary application architecture.

### BRIEF DESCRIPTION OF THE DRAWINGS

FIG. 1 is an isometric view of a golf simulator in use;

FIG. 2A is a comprehensive diagram of a golf simulator network system;

FIG. 2B is a more detailed view of a system employing components of FIG. 2A, including a data repository;

FIG. 2C is an exemplary representation of a possible information architecture and FIG. 2D a similar representation of the application architecture;

FIG. 3 is another conceptual network diagram of a LinksPlay™ system;

FIG. 4 is a diagram depicting a monetization concept; and

FIGS. 5-40 are exemplary interface screens illustrating various features and functions provided in accordance with the disclosed systems and methods.

The various embodiments described herein are not intended to limit any claims to those embodiments described. On the contrary, the intent is to cover all alternatives, modifications and equivalents as may be included within the broad spirit and scope of disclosure and the system as described herein.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

In the following description, an exemplary embodiment of a system is disclosed for possibly carrying out various methods. The system and associated methods are referred to herein as LinksPlay. The system will facilitate the context for interaction between a player and his or her self, or the player and other players, spectators or advertises in and around golf simulator play independent of time and location. More specifically, it will be a system that auto captures and resurfaces the collective intelligence derived from player-generated data after each and every golf simulator shot in the form of interactive informatics, enabling the player to analyze and discover their own performance insights as their game grows and develops over time. LinksPlay will also be a system where the players are essentially in complete control of their own experience, enabling them to more effectively define, initiate and manage personal or competitive events with themselves or with any other players in the network before and after golf simulator play. LinksPlay would likely include an Internet component that is public by default, enabling players, spectators and advertisers to interactively view and explore real-time action captured by the system. And it is the player interaction that sets the foundation for a set of monetization methods that facilitates the context for interaction between the advertiser and the player through an open Internet marketplace where, for example, the advertiser can bid and secure ads within specific slices of the player's or spectator's on-line experience.

The LinksPlay system is being developed to engage four user types that are referenced throughout the document and are generally characterized herein as follows:
Player—Member or registrant of any LinksPlay world-wide facility, club, café or connected simulator (also referred to as Customer);
Spectator—Anyone on the Internet that is not a player or advertiser (Prospect);
Advertiser—Current advertiser through LinksPlay system (Partner); and
Administrator (Corporate)—“manager” of the LinksPlay system that is connected to each of indoor golf sites or homes that contain one or more golf simulators.

All four user types will be interrelated with specific capabilities designed to better facilitate the interaction among them, which in turn will increase volume of interactivity and ultimately the profitability generated from the network over time. The LinksPlay system will include an integrated set of usage methods, system methods and monetization methods, several aspects of which are further described below.

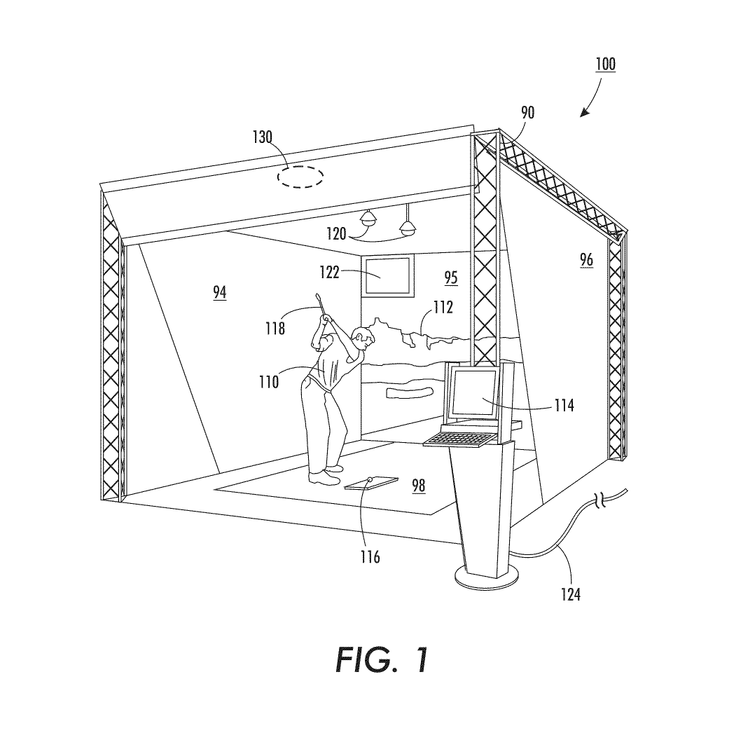

Referring now to the drawings where the figures are for the purpose of illustrating embodiments of the system and methods and not for limiting same, FIG. 1 illustrates a commercial golf simulation environment 100, also referred to as a simulator, having support frame 90 supporting an overhead cover 92 and three connected side panels 94, 95 and 96 around a horizontal playing surface 98. At least the central most panel (95 or screen 112) includes a bright durable material for the purpose of imaging a golf fairway from the vantage point of the golfer 110. Screen 112 therefore provides a virtual view, via a projection system (not shown), for the golfer to aim and stroke the ball using the club 118 that would be chosen for the same hole and location on an actual course. In this manner the player's swing is analyzed and feedback is provided on status panel 122 to assist in optimizing the distance and direction of the ball. Status panel 122 may be a separate display or interface, or it may be a “windowed” portion of the projected display on panel 95. It is this reiterative interaction between the player and simulator over a series of strokes that enables player 110 to identify stroke inconsistencies and practice remedial measures (e.g., stance and follow through) in order to attempt to improve his/her game.

Furthermore, the fundamental elements of the system shown in FIG. 1 include sensors (photographic, pictographic, etc.) 130 to sense the club swing and ball as illuminated by lights, for example 120. Sensors 130 are indicated as located above the golfer, but it will be appreciated that multiple sensors and associated optical elements may be employed to sense the ball direction, velocity, spin etc. For example, in the AboutGolf® simulators (aboutGolf, Ltd., Maumee, Ohio) a 3Track™, 3D high-speed photographic tracking system is used to sense the ball and/or club movement. Concurrently, the simulator or a separate system may capture real-time video images of the player, including addressing the ball, swing and follow-through. Such video may be captured and utilized, as described in more detail below, for streaming display of the player's performance in the simulator—where others might watch the play via remote devices.

The output of at least the ball sensor(s) 130 is received by a computer associated with the simulator, and processed to compute the trajectory, velocity and spin of ball 116. Once the physical parameters of a struck ball, as a function of club impact, have been calculated, other intrinsic factors are incorporated or modified by the computer operating the simulator to calculate or determine a flight path and subsequent ball landing location, bounce, roll, etc. Parameters that may be incorporated into the simulation include wind, clouds, rain, slope and condition of the ground (including fairway, rough, sand, water hazard, putting green, etc.) and possibly the time of day. These imputed characteristics strive to instill the realism of actual play thereby yielding results that can be correlated more closely to the actual topography.

Aside from the simulated events such as playing, practice at driving range, putting, etc. several ancillary features are provided using the simulator or associated systems. As depicted in FIG. 1, one such feature is a walk-up terminal 114 having a multitude of functionality related to simulator set-up, charges, scheduling and organization of events including matches and tournaments. In addition the simulator terminal has a WAN connection to allow for simulator-to-simulator play as well as remote access to player specific performance and other such data.

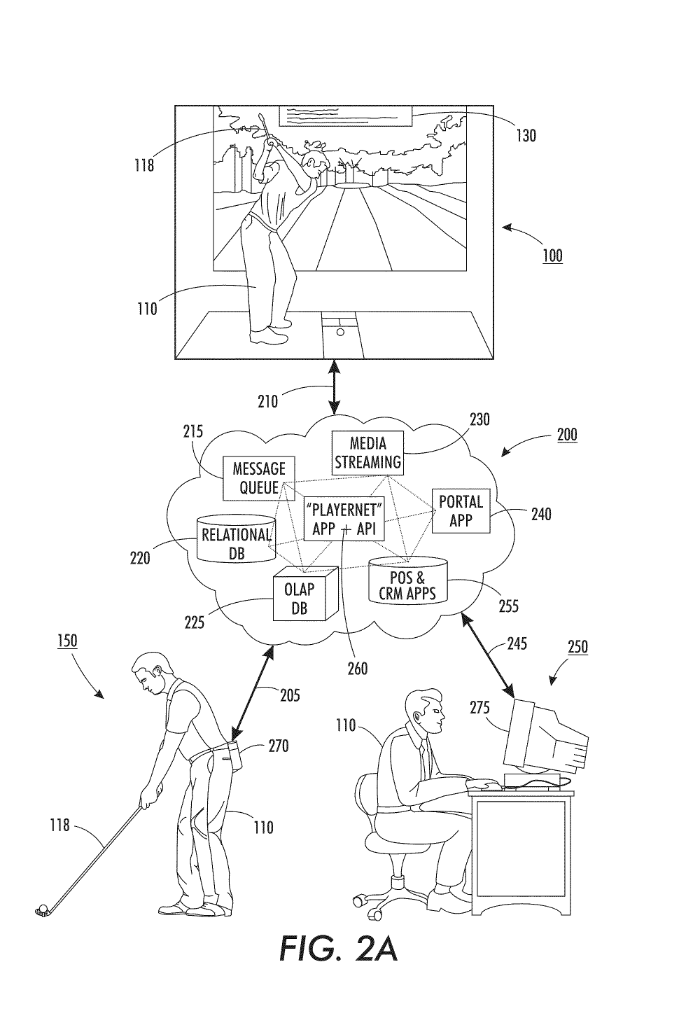

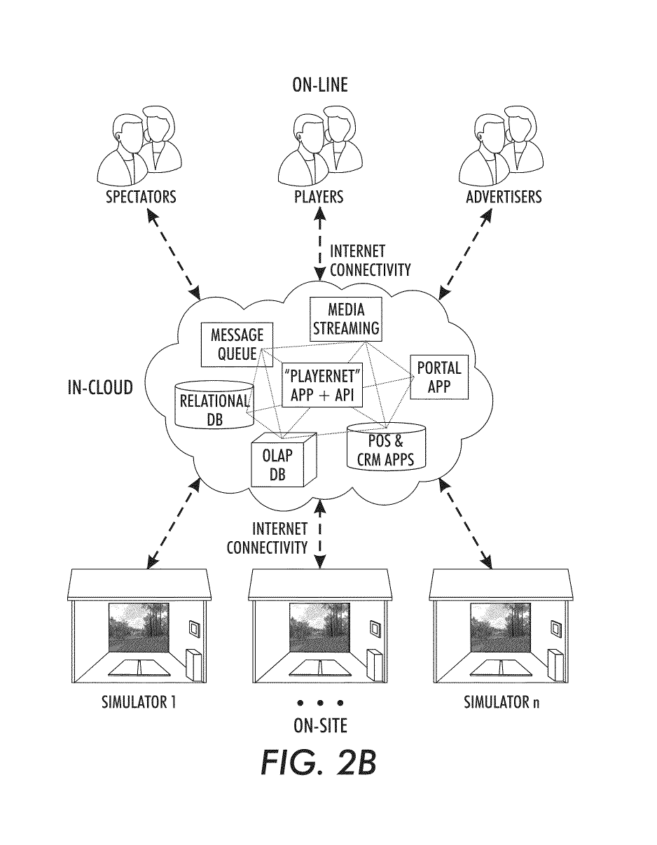

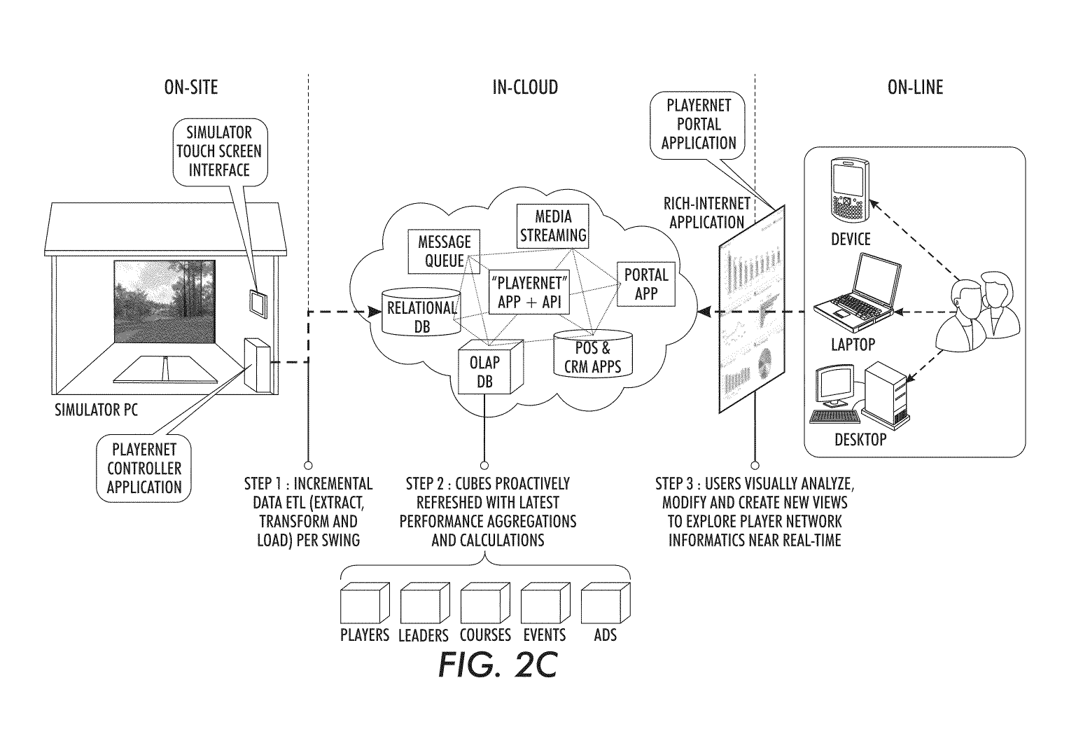

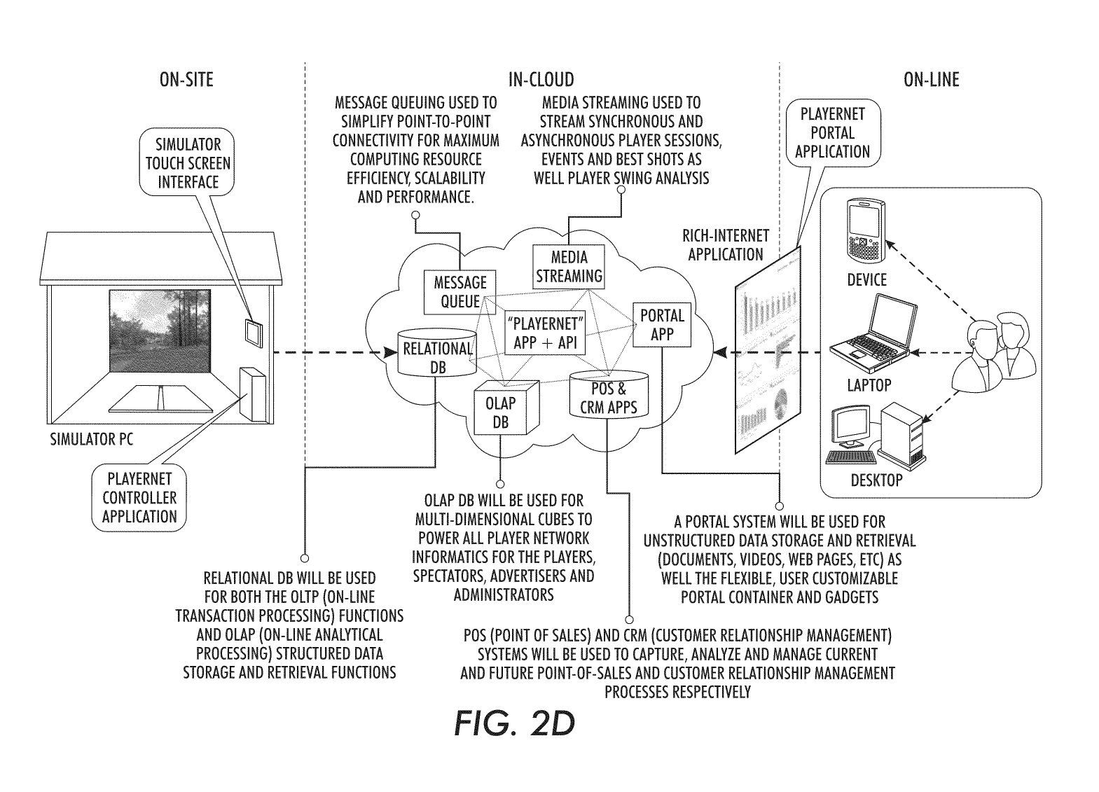

Next, reference is made to FIG. 2 where an exemplary system for the disclosed embodiments is depicted. The system comprises various Internet applications represented in cloud 200, as well as alternative points of access, possibly via an Internet connected home computer, workstation or portable device 250 or personal or portable device 270 for use on the actual course. It will be appreciated that the devices 250 and 270, although described herein in further detail, include not only various personal digital assistance devices but also smartphones (e.g., iPhone® or iPad® by Apple, and Droid® by Motorola) and similar or future devices that operate via downloadable programs referred to as “apps.”

As depicted the system includes an application rich cloud 200 that serves to enable network access (local, wide area/global) to various processes by using the Internet as the backbone of the cloud 200 network. It will be appreciated that the cloud includes one or more computers and associated memory and storage to not only provide the programmatic control of the computers but also to provide support for and exchange data with the simulator 100 as well as other workstations 250 and devices 150. The term Web 2.0 is commonly associated with web applications that facilitate interactive information sharing and collaboration on the World Wide Web. Examples of Web 2.0 include web-based social communities, such as FaceBook and My Space, hosted services, such as wikis and blogs, and browser accessible applications. A Web 2.0 based site allows its users to interact with other users or to alter website content, in contrast to non-interactive websites where users are limited to the passive viewing of information that they have solicited. The present disclosure contemplates use of the Internet as a platform by enabling users, in the disclosed embodiments golfers, to access and run software-applications entirely through their browser and in effect control over the data on a Web 2.0 site. This capability has fueled the growth of Rich Internet Applications (RIA) as well as the emergence of new application platforms that are appealing alternatives to traditional on-premise resident software. Typically RIAs are interactive, desktop-style applications that are installed on a single server and accessible from any portal via the Internet. It is also the visual, interactive and immersive experience that can only be created through RIAs that lends itself as the ideal client platform for LinksPlay.

A cloud-based RIA may provide the appropriate base for the LinksPlay™ system (FIG. 2), which will now be discussed to more specifically in relation to a golf simulator(s) and a related community of participants.

Firstly, point of sale (POS) or similar software will be used to capture, analyze and manage the financial aspects of a client's account. Customer relations management software (CRM), 240, such as Microsoft Dynamics CRM 4.0 will facilitate customer interactions. In one contemplated aspect of system 200, Microsoft Silverlight™ 260 will be used to provide a cross-browser, cross-platform and cross-device plug-in that enables the LinksPlay application 200 to deliver applications over the Internet. Additionally, Microsoft SharePoint 225 may be used as the portal for player content and access management and Microsoft Service Bus 215 will simplify point-to-point message queuing connectivity for maximizing computing efficiency, scalability and performance. Lastly Microsoft Streaming will be used to support synchronous and asynchronous transmission of captured video from player sessions and events as described above, as well player swing analysis. More specifically, use of a media streaming server or service (e.g., see FIG. 2D) provide the ability to view events (synchronous or asynchronous) via actual video streaming of the virtual golf play “live” or recorded.

An interface 205, 210 or 245 supports the ability to exchange data and other information between the various devices described and may be conventional wired or wireless interfaces that operate using standard Internet protocol (e.g., TCP/IP). Such devices, in one aspect of the disclosed embodiment permit players to auto configure LinksPlay 200 on-line and in advance of play. In other words, a payer may arrange or “book” a simulator to participate in an event (driving range, play 18 holes, etc.) in advance and simply arrive at the simulator (or a café where a plurality of simulators are provided) and once signed in begin play without further configuration—where the player's information is already available to the simulator via the interface to the cloud platform 200.

Once a session is commenced sensors 122 transparently capture shot data and swing metrics for every shot played or attempted without further golfer intervention. As currently contemplated, LinksPlay application 200 will further include or provide access to a multi-dimensional relational database or data repository 220. The database functionality may be provided by Microsoft Azure, residing on SQL Server 230 or a similar database system, and will store the golfer's data that is not only entered by the golfer at the time of sign up, or subsequent editing, but also the particular performance-specific data uploaded from the simulator 100. The SQL database will be used to not only store raw data from the simulator, but may also be employed to store and provide access to analytical data, event tracking, etc. as will be described relative to the user interfaces characterized below. Thus, the database 220 will be employed to store information for both on-line transaction and analytical processing functions relating to the performance and needs of the golfer, of administrators and of vendors or others that have a relationship to LinksPlay.

Player informatics are further employed for presenting golfer metrics through the use of one or more visual displays (e.g., multi-dimensional cubes) to provide near real-time player, course and event leader board statistics and trending. In addition, advertiser informatics may be created using the data base data to enable experience-based monetization in order to analyze and manage current and future potential for real time point-of-sales and customer relationship management processes.

The player will be able to form personal playing groups (e.g., teams, leagues, foursomes, etc.), as well as participate in and organize public or private events between players or groups at the same physical site or across multiple sites. Such events may also extend over periods of time to provide greater convenience and accessibility for those participating. In other words a participant in a tournament or other group event can accept an invitation or otherwise agree in advance of on-site play, and then simply play at a time/location that is convenient instead of having to play on Saturday morning at the local golf course. Therefore, the LinksPlay application 200 is, in one sense, an interface that will enable users to design and control events that they participate in, and thereby administer both on-site drop-in players, as well as contestants in a tournament. Furthermore players will be provided a global portal to explore, and perhaps share, player performance data, statistics, profiles, and event leader boards interactively.

LinksPlay Mobile 150 is an on-course subset of the above-described player portal, wherein several features and functions described in further detail below, may be accessed while on a golf course. The mobile device 270, which may be designed to both deliver/display personal information for a golfer (e.g., average distances for clubs), may also record key personal metrics in a portable Internet enabled data acquisition device (e.g., strokes/hole, shot distance based upon GPS of other distance calculation between strokes, etc.). Take the yardage from a given range finder and then query the LinksPlay database to determine which club would be ideal based on the player's performance statistics. Lastly, Links Play Mobile provides continuous connectivity to players and spectators world-wide anytime, anywhere and on any device.

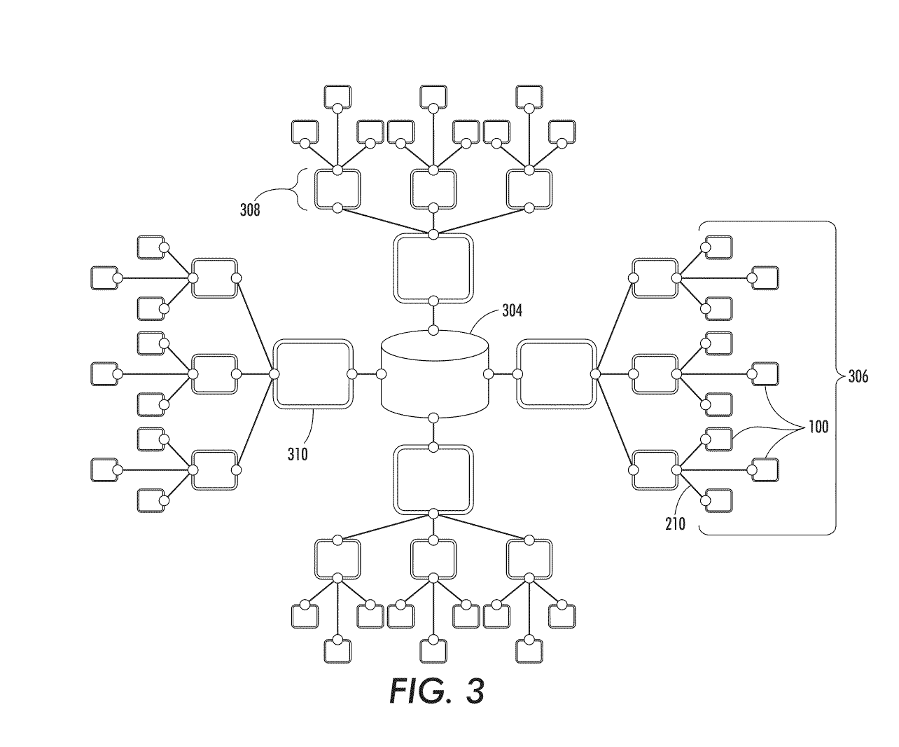

FIG. 3 is an exemplary illustration depicting one layout of a virtual golf community comprising interconnected golf simulators 306, connected via wide area network interface 210 to Internet service providers 308 which in turn are interfaced with backbone servers 310. One or more of the servers operate programmatic code for controlling the LinksPlay application which in turn uses a centralized database or repository 304. In the example of FIG. 3, a player would arrive on any simulator site in the world, login at the simulator, select their pre-defined event and the LinksPlay application would auto configure the event, and position the player on the first tee, or possibly the next hole when continued from a previous session. As seen in FIG. 3 each shot played in any event in a simulator anywhere within the LinksPlay Community 300 is captured and feed back to the data repository, which may also include video data captured while the player is engaged in the event. In a typical situation the data is public and all the players, as well as their visual informatics, may be shared with a group independent of geography, demographics, or language.

As described herein an embodiment of the system, or for carrying out the various methods necessary to implement the LinksPlay functionality will require the ability to store and access information (raw data, processed/analyzed data, stored images and video, etc.) and to do so in an efficient and timely manner. Such a system will, however Benefits Physical Play of a user by providing increased opportunity to participate in events, both through know contacts and interactions as well as through increased network contacts facilitated by the system. As noted above, the system will be designed to be device independent, and based upon a cloud-based system to enable scalability as well as to facilitate additional means for access to the data collected and stored by the system.

As noted above, a particular simulator or standardized may be employed with LinksPlay, thereby providing a controlled environment and minimizing or eliminating differences in performance between one simulator or another. It is further contemplated that the LinksPlay system itself, due to the data being collected across multiple simulators and various players, may be able to “calibrate” or otherwise statistically determine and adjust for minor discrepancies in the performance of such simulators. Furthermore, the data repository of LinksPlay may also be used to store calibration data that can be used to periodically test and/or troubleshoot simulators that have been identified as possibly falling out side of nominal operating range. As such the simulators will provide a controlled and consistent environment for the players, regardless of the simulator in which the play.

One possible source of revenue to be derived from the LinksPlay application is from membership fees which have various feature levels. However, in collecting and feeding back performance data to the player another significant opportunity exists whereby contextual marketing may be facilitated, both historical and real-time.

Consider, as one possible monetization method, where an open, on-line marketplace is created as part of the on-line application that enables advertisers to bid for rights to advertisement space in the context of the user experience of the very same application and when secured, the advertisement(s) becomes dynamically and seamlessly integrated into the user experience without any additional software development and integration while the advertisers would obtain a real-time channel into their ads analytics, performance and automated financial transaction processing.

As presently conceived, there are at least four experience channels the advertiser might utilize to reach the user's experience:
Actor Tagging—The advertiser in real-time can tag an existing on-line actor with a product or service brand, creating a more effective connection between the performance of the actor and a given product and service;
Venue Creation—The advertiser creates on-line venues that better align the environment for interaction with the values and attributes of the product and service to be advertised, which in turn increases effectiveness of the overall advertisement campaign;
Event Tagging—The advertiser bids for the rights to host and tag an existing on-line event with rich, contextual ads that are seamlessly integrated into the experience, which in turn increases not only brand and product awareness, but the effectiveness of the overall advertisement campaign; and
Data Tagging—The advertiser bids for the rights to tag data spaces with rich, contextual ads that are seamlessly integrated into the user experiences where the data spaces are in context, which in turn increases not only brand and product awareness, but the effectiveness of the overall advertisement campaign.

Experience-based monetization is generic and can be easily applied to wide range of on-line applications and related to products and services. But not all businesses will realize equal return on similar investment. The greater the collective intelligence and network effect potential of the on-line application the greater the number of related information and capability assets that are contained and controlled by the owner of the on-line application, and thus the more the on-line application enhances the existing products and services, the greater the potential return on investment.

To help further illustrate the applicability of experience-based monetization, consider the following examples relative to the LinksPlay planned system and methods described herein:
Actor Tagging—An advertiser sponsors the top five most accurate iron players in the network, which could even include the players agreeing to use the advertiser's product or service to compare and contrast the performance of the player before and after the product and service usage;
Venue Tagging—An advertiser assembles the best Par 3 holes between 180-220 yards as a venue for “Hybrid Club Challenge” events (i.e., an advertiser-created event that highlights or encourages use of the advertiser's product in some way), controlling the environment to enhance the value of their new hybrid club;
Event Tagging—An advertiser sponsors a region (e.g., state-wide), multi-round, longest-drive contest to advertise their newest driver, which could even include demo drivers in each of the participating LinksPlay simulator centers or cafes;
Data Tagging—An advertiser buys the wedge data space for higher skill players during the later part of the off-season prior the launch of their latest wedge product, an ad on their new wedge is seamlessly integrated into the player's experience when they are analyzing their GIR (Greens in Regulation performance metric) data/performance trends.

As noted earlier, subscription-based monetization may also include data-subscription monetization, where a generic on-line marketplace is provided where subscribers (e.g., vendors, suppliers) can bid for rights to anonymous but characterized performance data spaces within an on-line application through direct system connectivity and access. In LinksPlay, for example, golf club manufacturers could buy the rights to anonymous but demographically characterized performance data from the player network, providing unique product development insight and feedback into the performance characteristics of a given club, which could even include demo club trials for real-time performance analysis through the network.

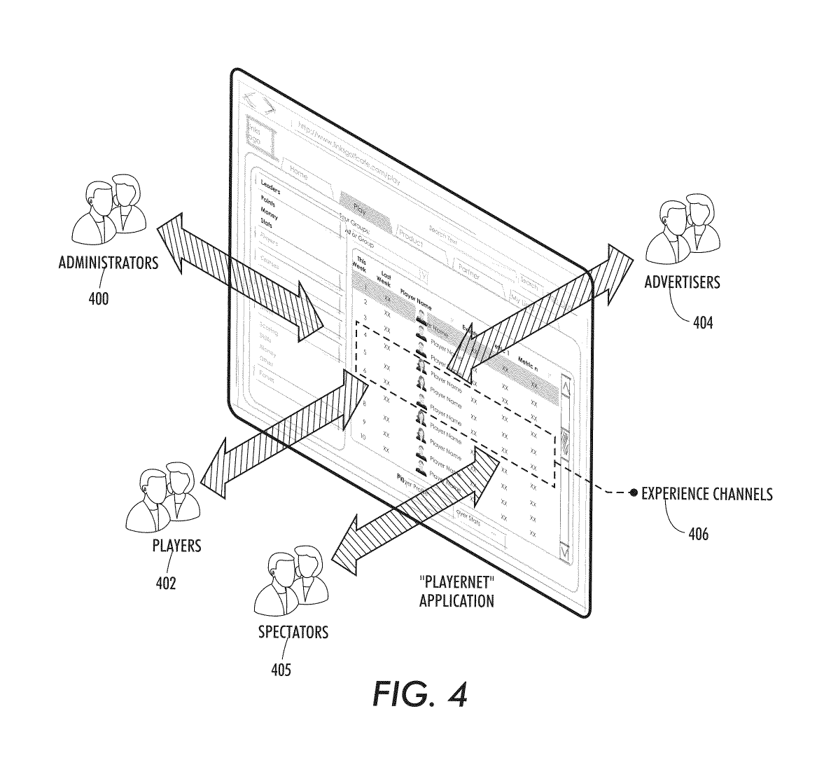

Considering FIG. 4 in light of the experience-based monetization construct, depicted therein is a representation of “experience based monetization”. The overall process may be facilitated by the LinksPlay system under the control of an administrator 400. Considering an example, assume that user-generated data is streaming into the cloud database live from each simulator in every site for every shot, providing the feedback loop (player statistics, player boards, player events, etc) that creates a cycle—the more the player 402 plays the greater the value of the information provided back to the player, to other players, as well as to advertisers 404 and spectators 405. Once the data is modeled properly, LinksPlay will know everything about the player (location, profile, performance, etc.) as they engage on-line, especially when they view their own performance data. And if you look at golf club manufacturers, for example, there is almost a perfect alignment between how they segment their product lines with how players will likely view performance data with the following potential usage scenarios:
Player 402 is analyzing performance metrics such as Driving Distance and Accuracy trends on a display interface and a fresh ad from a vendor (e.g., Callaway) 404 on their latest driver is seamlessly integrated into the viewing experience;
Player 402 is analyzing Greens Hit in Regulation trends and a fresh ad from a vendor (e.g., Cleveland) 404 on their latest wedge is seamlessly integrated into the viewing experience; or
Player 402 is analyzing Average Puts per Round trends and a fresh ad from a vendor (e.g., Odyssey) 404 on their newest putters is seamlessly integrated into the viewing experience.

In another, ad-based monetization method, if players click on or otherwise acknowledge the ad, then the system collects one level of revenue from the vendor, and if the player then makes a purchase, a higher level of compensation is provided. The ads can be smart and dynamic by location (local ads, etc.), profile (male, female, etc.) and (skills targeted, etc.) performance. The on-line ads could just as easily extend to golf attire, lessons, travel and every other golf related product and service in the industry.

As further contemplated by the disclosure herein, the LinksPlay application and system can be designed as an “open marketplace” for golf-related businesses to bid and compete for what are referred to as “experience slices” (e.g., the interactions described above). Just as LinksPlay is a designed as a self-service system for “players,” the same principles may be applied in designing the advertisement interface—to provide a self-service system for “advertisers.” The “experience slices” could start with a set price determined by location, profile and performance and by timeframe (season, off-season, holidays, etc) and the “open marketplace” (e.g., bidding) may then be used to determine fair market value. Once a bid is secured, the advertiser could then insert their ad via the LinksPlay web ad template, all on-line without any code revisions required. It is further contemplated that the entire “open market” could be completely automated wherein each “advertiser” gets real-time views into their ad analytics, performance and automated billing and financial transactions.

Having generally described a monetization methodology, reference to FIG. 4 continues to further illustrate the concept of monetization of player data, where an on-line marketplace is created as a function of data acquired from the golfer's performance, needs and/or interests. The advertising application produces an interactive display 406 for LinksPlay, via programmatic code residing within or as an add-on to LinksPlay application 200, and enables golf related suppliers/vendors 404 to bid for or purchase access to player data in order to target advertising that is then dynamically integrated into the LinksPlay user experience. This monetization method, based largely on access to player data, will provide a real-time contextual channel for advertisements, and may also permit tracking of marketing performance.

Additionally, transaction processing may be automated through LinksPlay advertising 406, whereby a player profile may be referenced for shipping, billing and payment. In the case of a player that is simply shopping within LinksPlay, compensation may be derived/realized on a per-click basis. Thus, ads may be logically presented to players based upon player usage or performance data.

In summary, the monetization aspects of the disclosed system and methods include the following categories:
Open Marketplace—advertisers can bid and secure ads on-line and in real-time with the application;
Open market analytics—advertiser has full access to user, event and data analytics in the network for pre, active and post ad analysis;
Experience-based—monetization based on advertisers buying and tagging experience “slices” (actors, events, data) with in context ads;
Subscription-based—monetization based on advertisers buying data subscriptions for rich, live performance insights into their or their competitors products within the network; and
Dynamic integration—dynamic integration of ad into a live interaction application, without any code or development requirements

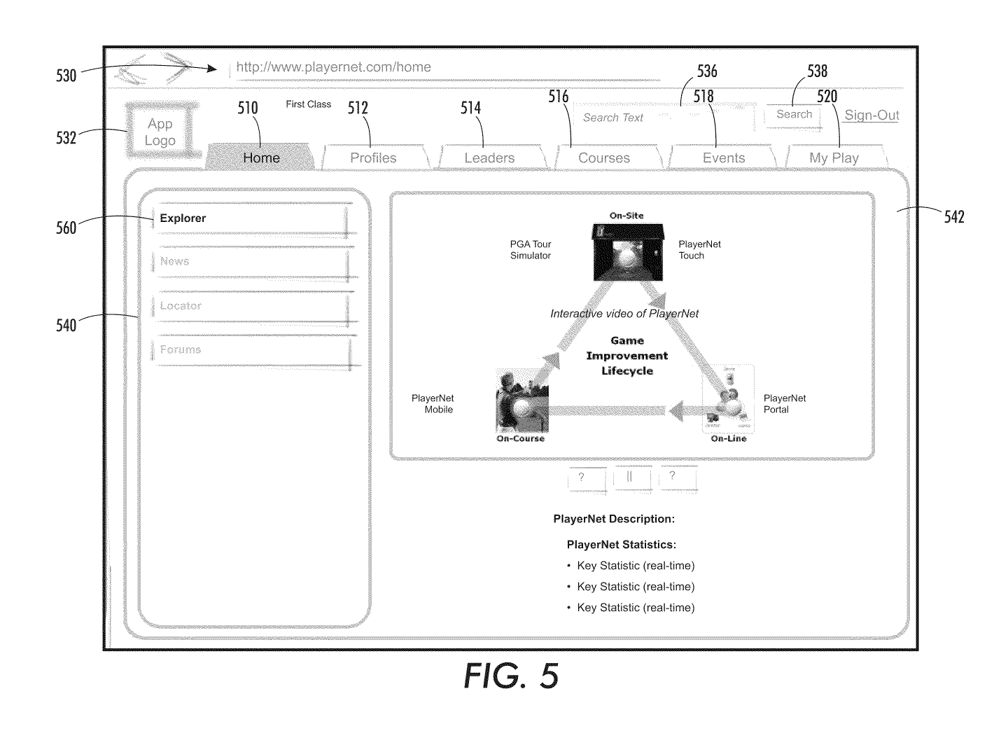

Having described various aspects of the LinksPlay system and methods for its use, attention is now turned to various exemplary interface views that serve to further illustrate the features and functions of the LinksPlay system. The following discussion will be broken down into aspects of the user experience related to the tabbed elements of the player interface (e.g., FIG. 5): Home (510), Profiles (512), Leaders (514), Courses (516), Events (518), and My Play/Private (520). As will also be seen in FIGS. 5-40, each proposed interface screen may also include the URL display region 530 along the top (representative of typical browser interface), a LinksPlay or other customized logo 532, as well as a tradition search feature represented by search text window 536 and search button 538. Each interface screen may also include a navigation bar 540 related to a particular tab, and a user-interactive region 542. As noted the information displayed in regions 540 and 542 is dependent upon the tab and navigation link, and to a certain extent the user/player. It should also be understood that various formats may be employed for the display, including formats that are automatically adjusted to operate, for example, with personal devices such as smart phones providing Internet access or running particular applications. Thus, the interfaces displayed herein are for purposes of illustrating the features and functions of the disclosed system and methods, and are not intended to limit the embodiments described. The various regions and windows depicted in the interface screens of FIGS. 5-40 may, of course, be modified in size and layout as such features are conventionally adapted in a browser or similar application interface.

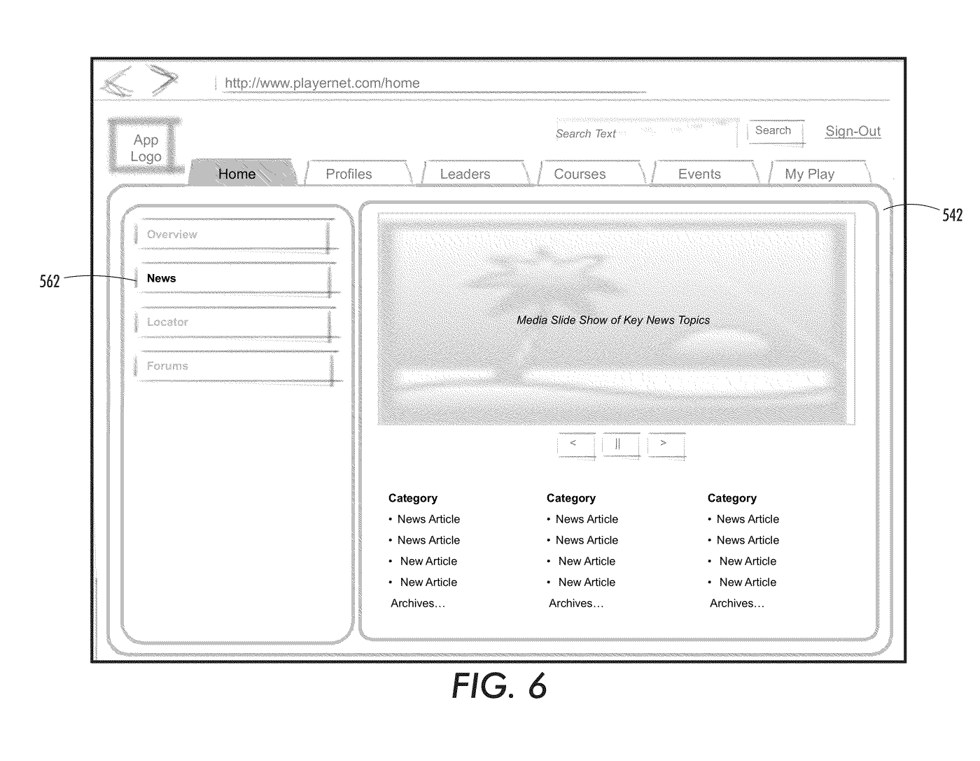

Referring to FIGS. 5-8, depicted therein are various illustrations of the interfaces corresponding to the Explorer, News, Locator and Forums navigation buttons 550 as found in region 540 of the interface. In FIG. 5, the Explorer button 560 presents an overview of LinksPlay as well as several key statistics relating to the LinksPlay system such as number of players in the system, number of events/week, number of new players in system/week, etc. As illustrated in FIG. 6, selection of the News button 562 results in a user being provided with an interactive screen in region 542 to review news articles (e.g., latest ESPN golf feed, local golf news, weather, etc.).

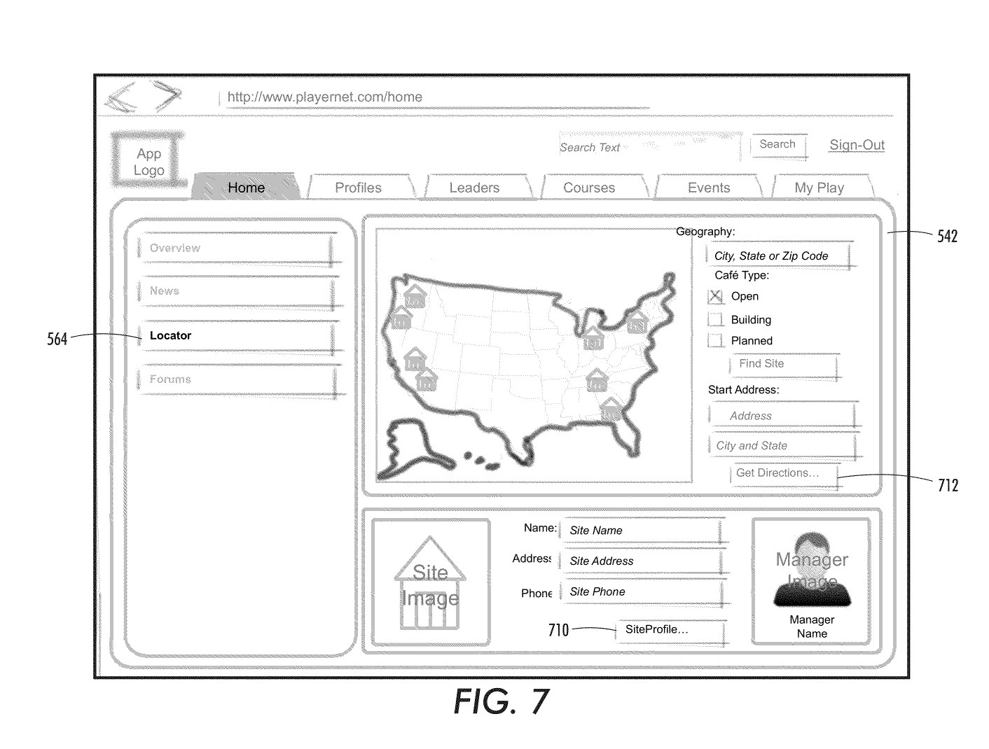

Selection of locator button 564 produces a regional or national map 708 (possibly responsive to an IP address or other location information) of LinksPlay locations for a user to review in region 542. In one embodiment, the map may have location identifiers which, upon selection or mouse-over, depict the details of the location including the data indicated. Selection of one or more links within the data field may lead to further updates of the display region 542, for example providing a narrative site profile (button 710), photos of the site, local map or driving directions to the site (button 712), listings of site-initiated tournaments or of players identifying the site as their home site, etc.). The interface of FIG. 7 also contemplates searching for sites by entering geographical information in the fields indicated along the right side of region 542.

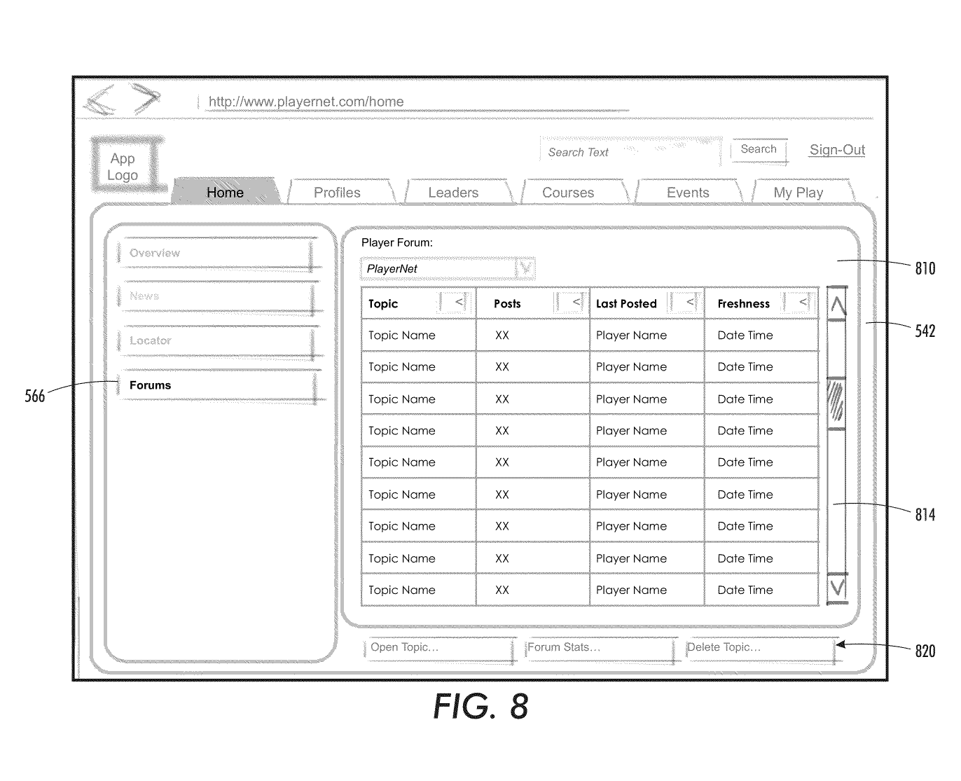

As illustrated in FIG. 8, selection of the Forums button 566 presents the user with a listing of forums or what are often referred to as discussion threads 810 in region 542, which the user can then access to discuss the topics indicated. The discussion forums are organized and may display various relevant data about the forums, including not only a topic or title, but the number of posts, last posting date, etc. as illustrated in FIG. 8. It will be further appreciated that if a user selected one of the topics, the display in region 542 would be updated to depict the further details of the topic as well as the most recent posts. As the display of topics or posts within a topic may exceed the display capacity of region 542 it will be noted that the display is illustrated with scroll-bar 814 along the right side of region 542 to facilitate scrolling or browsing the various topics, posts, etc. The display in region 542 of FIG. 8 also includes various navigation buttons 820 along the bottom that permit the user to interactively communicate with others by opening a topic, obtaining statistics on the forum (e.g., number of posters), or possible deleting a topic that he/she may have started.

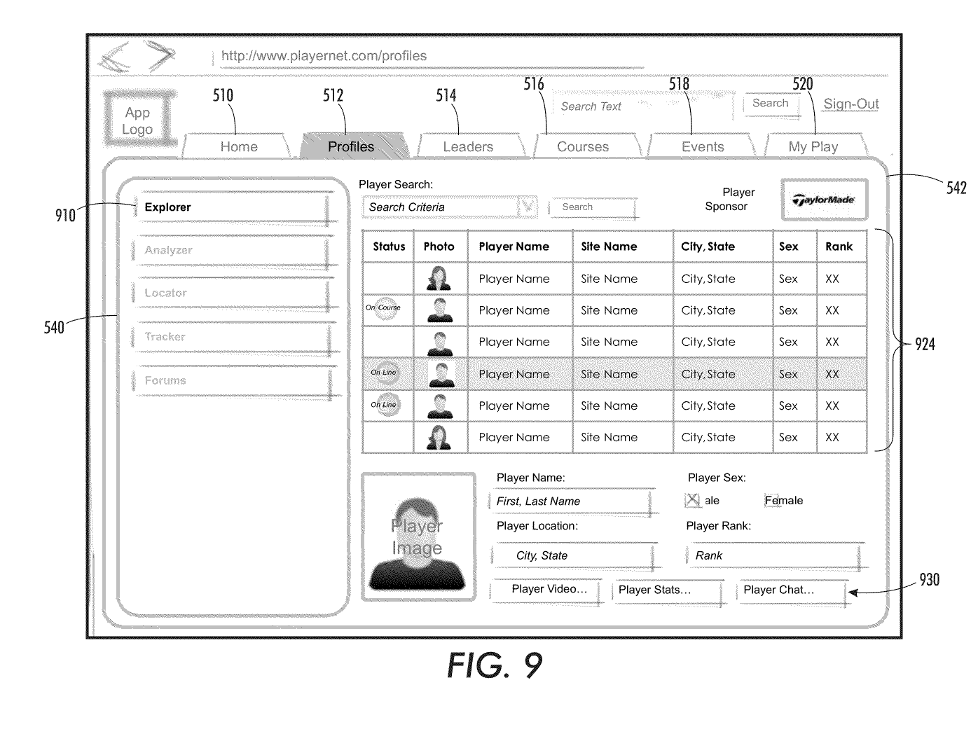

Turning next to FIGS. 9-13, illustrated therein are exemplary interface layouts for the various features enabled using the profiles tab 512. Referring to FIG. 9, the explorer button 910 in tab 512, produces a player listing in region 542 based upon search criteria entered in the lower part of the region. As illustrated the search may be on one or more of the follow exemplary characteristics: name, location (city, state, zip, LinksPlay site, etc.), gender, ranking, etc. The listing may be adjusted or altered in response to a change in search criteria or ordered in accordance with one or more criteria (e.g., by males with highest ranking, or females by site, etc.). If the user selects on or mouse-over a player in the listing 924 the details for that player are illustrated at the bottom of the display region 542. In addition, one or more buttons 930 may be selected to view video of the player, see the player's statistics or even to open up a chat window to facilitate further interaction with that player.

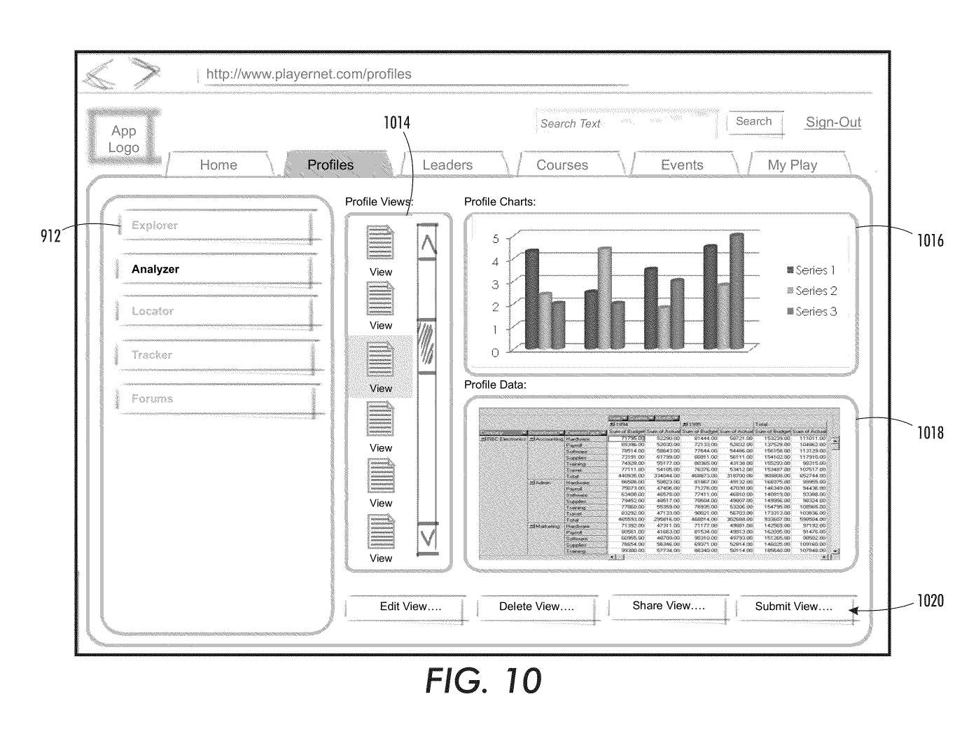

Considering the example interface of FIG. 10, depicted therein is an analyzer feature corresponding to navigation button 912. The analyzer is intended to provide the user the ability to analyze, modify or create new data or chart views interactively rather than limited to static views, empowering the user to explore and discover their own insights, whether a player analyzing their performance, a spectator following the top leaders in the network or an advertiser determining which player or event to potential sponsor. The profile views in region 1014 show the standard, most commons views to analyze or modify, making it simpler for users to get started with their own analysis. The profile charts 1016 illustrate the view in visual form, allowing the user to pick and choose the type of charts the best suites their particular analysis, for example, a user may choose bar chart to analyze how players there are in the network by region, area or city. And, the profile data in region 1018 represents the view in data form. Buttons 1020 provide functionality for editing, deleting, sharing and submitting user-developed profiles as described. It should be appreciated that this description is generic and can be applied to all other “analyzer” sections as mentioned in relation to other interface displays below, the only thing that changes is the context of the data, that is what the user is analyzing, e.g. leaders, events, etc.

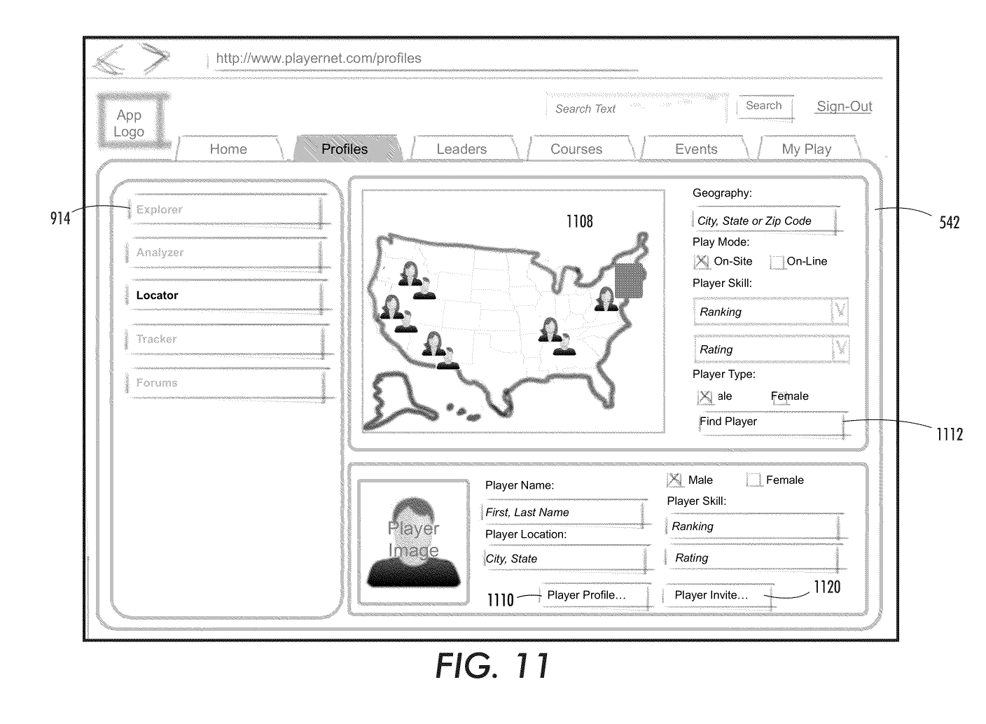

Turning next to FIG. 11, Selection of locator button 914 in the profiles tab produces a regional or national map 1108 (possibly responsive to an IP address or other location information) of player/user locations for a user to review in region 542. In one embodiment, the map may have location identifiers which, upon selection or mouse-over, depict the details of the location including the data indicated. Selection of one or more links within the data field may lead to further updates of the display region 542, for example providing a profile of the player (button 1110), photos of the player, etc. The locator also facilitates searching for other players by geographic location, mode of play, skills (ranking, rating), gender, etc. where upon entering one or more criteria and selecting the “find player” button 1112 players are identified on a map 1108. Once a player is identified or located, the player may be invited to play or participate in an event (round of golf, match play, tournament, etc.) by selecting button 1120.

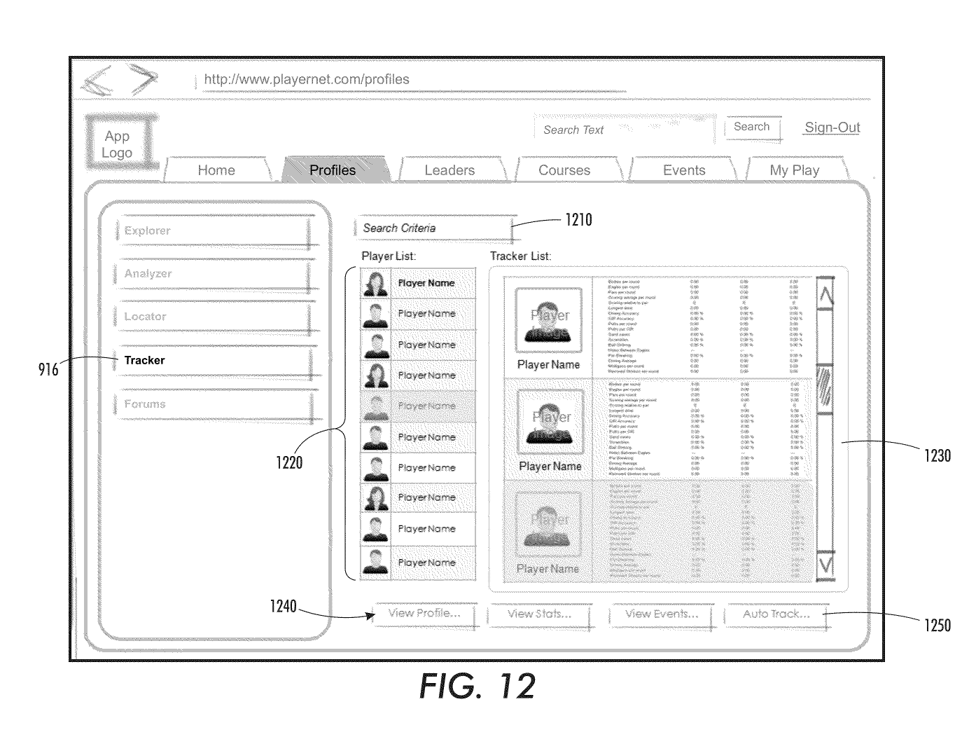

The player tracker function, as illustrated in the interface display of FIG. 12, provide a user of the LinksPlay system with a means for checking or “tracking” the performance of other players. More specifically, upon selection of the tracker navigation button 916, the user is presented with a search function (search criteria window 1210) that allows the user to search various players based upon predefined criteria that may be selected from a pull-down or similar menu, or that may be entered manually. From the resulting list, the user may select one or more players to be tracked, and the performance data for the selected players then appears in region 1230. Again, depending upon the number of players that the search identifies or are selected for tracking, the displays in regions 1220 and 1230 may include scroll-bars to easily navigate the list. If a user selects a particular player from the tracker list in region 1230, button 1240 may be used to view the tracked player's profile, statistics, events, etc. The Auto Track button 1250 provides the additional functionality of having the system perform at least some level of tracking (e.g., status of an event, tournament lead changes, etc.) based upon user-entered criteria.

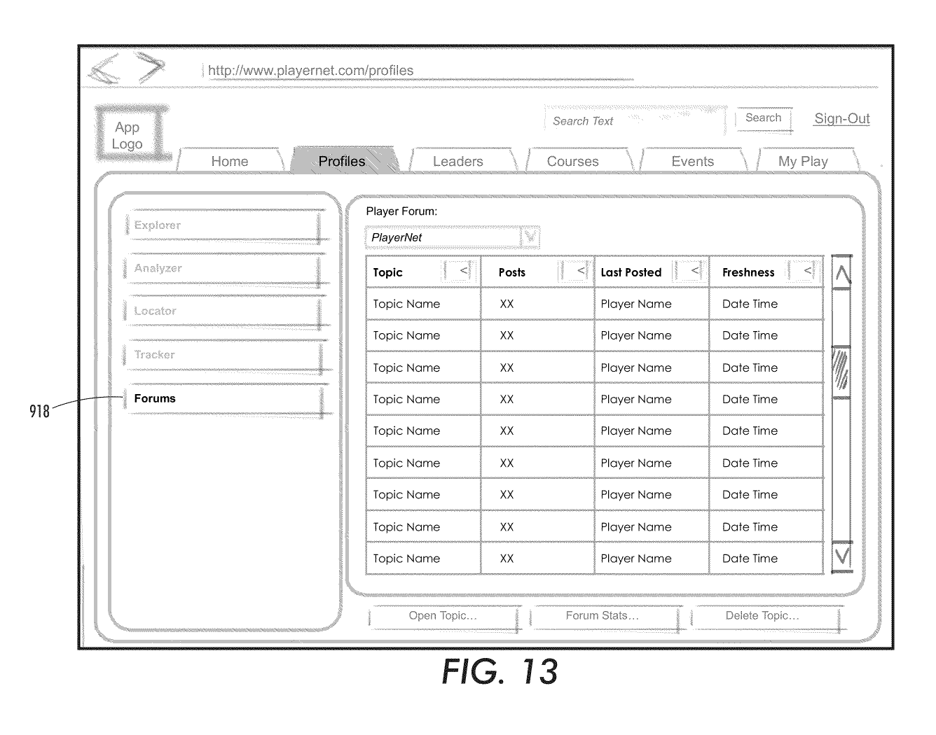

In a manner similar to that described above relative to FIG. 8, the interface of FIG. 13 provides a player with access to forums via navigation link 918. Access to forums is provided so that the player can provide textual comments, discuss topics or issues for discussion with others, thereby encouraging and increasing the social interaction amongst users, spectators, etc.

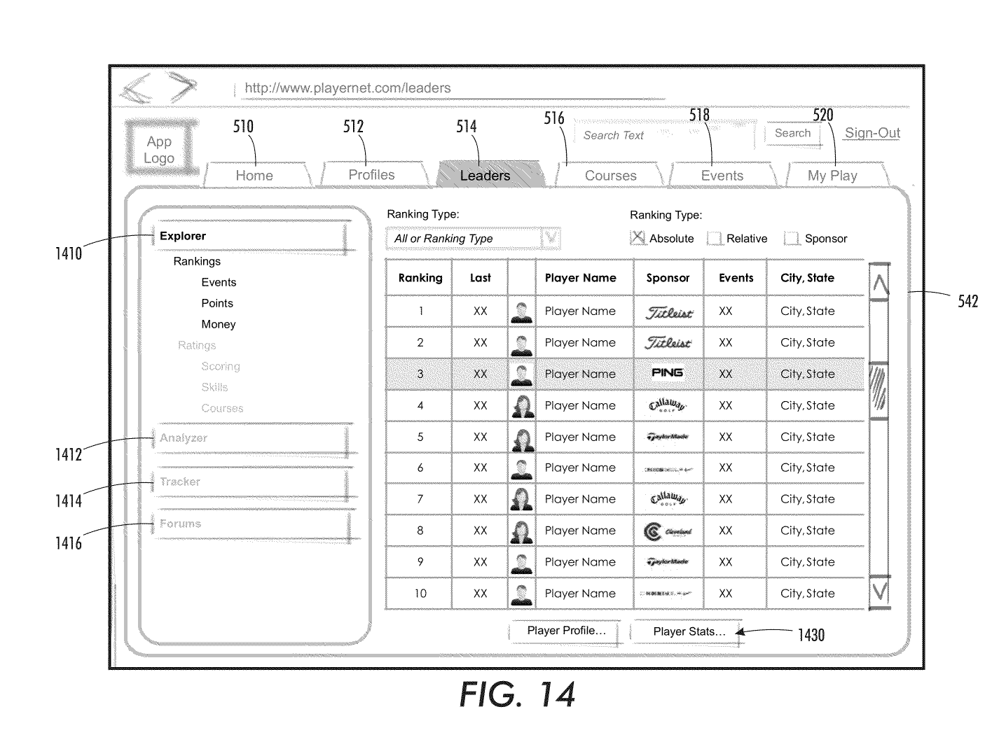

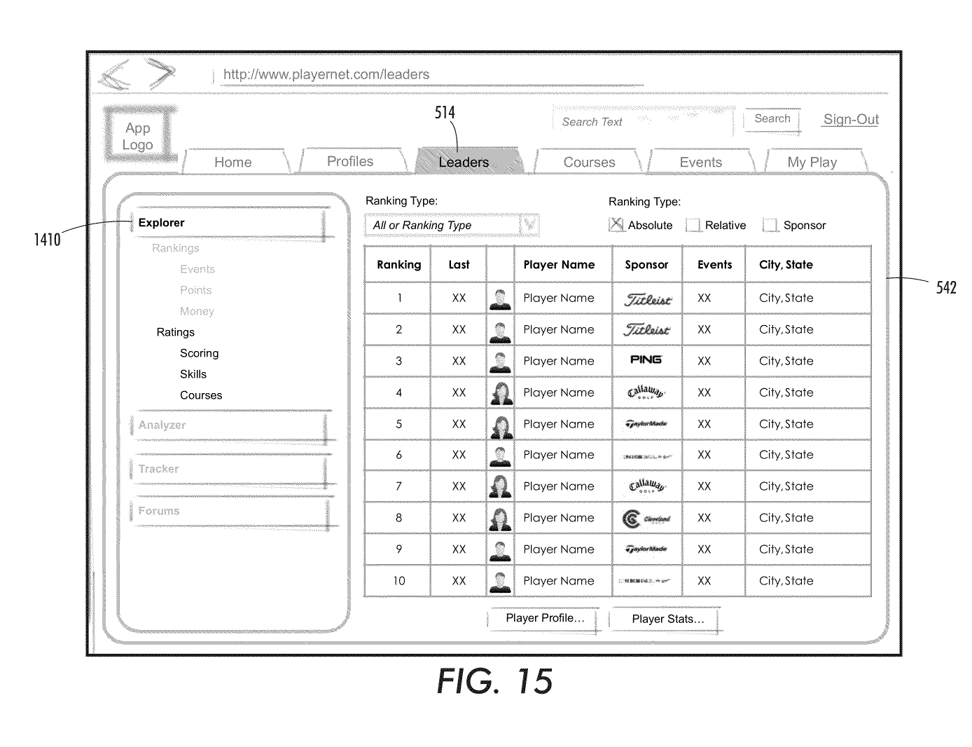

Having described the functionality of the LinksPlay system relative to the various features under the Profiles tab (512), attention is now turned to the functionality enabled via the Leaders tab 514 as described relative to FIGS. 14-18. Referring, for example, to FIG. 14, under the leader tab, the navigation links or buttons again include explorer 1410, analyzer 1412, tracker 1414 and forums 1416. As will be appreciated the analyzer, tracker and forums links operate much in the same manner as described above, but with the focus or navigational components being directed to the leaders based upon ranking or rating. As illustrated by FIGS. 14-15, the explorer link is further broken into two display formats—the first based upon ranking (FIG. 14), which is based on player performance in sanctioned or official events, and the second based upon rating (FIG. 15), which is based on player skill performance against pre-defined player levels (absolute rating) or other players in the network (relative rating). In the ranking display of FIG. 14, a listing of ranked players is displayed in region 542, where the list includes data for each player such as ranking, last ranking, an image or graphic representing the player, the players on-line name, a sponsor, a current listing of events the player is participating in, and the location of the player. The Ranking type fields at the top of region 542 provide the ability to assess a player's performance relative to others. And, as in the prior description, selection of a player I the listing, followed by the selection of buttons 1430 presents the user with the player's profile information or statistics. In FIG. 15, the players are illustrated in the list in region 542 by ratings, again displaying similar information for each player and permitting them to be selected and further information obtained about a player in the same manner as described relative to the interface of FIG. 14.

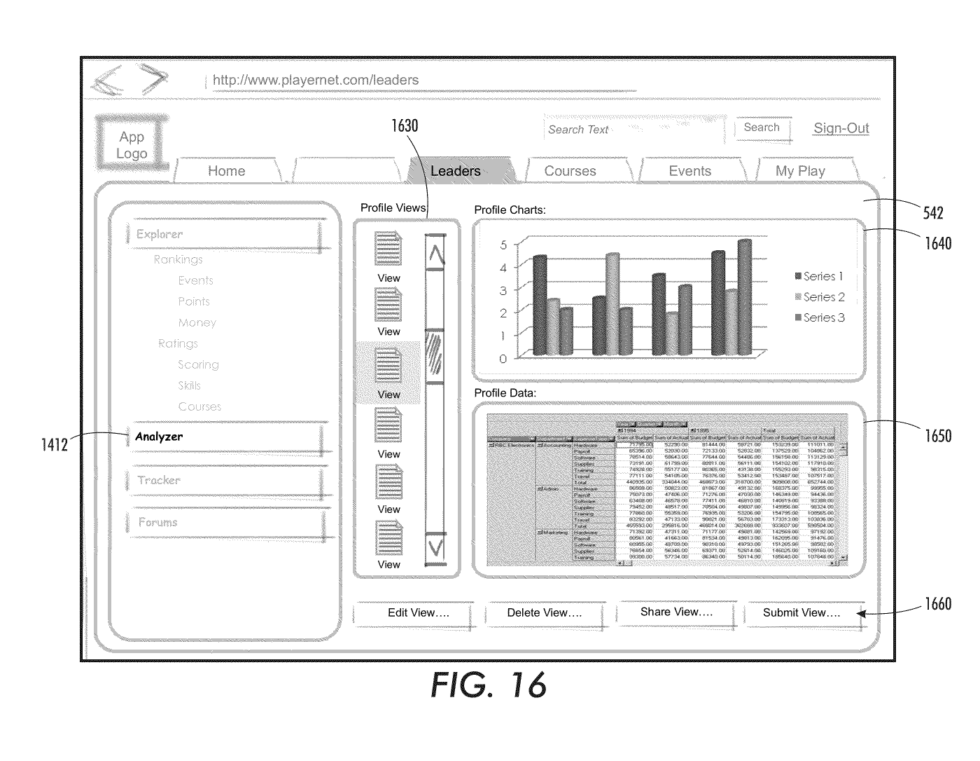

Turning to FIG. 16, under the leaders tab and analyzer navigation link, region 542 is used to display various views depicting the data in the LinksPlay database related to leader information. Here, the views to be shown may be selected from a scrollable list of views represented as thumbnails in region 1630. Selection of a leader view in region 1630 automatically updates the display of information in the leader chart 1640 and leader data 1650 regions of the display. In this display the user can also create, edit, delete share and submit views as represented by buttons 1660.

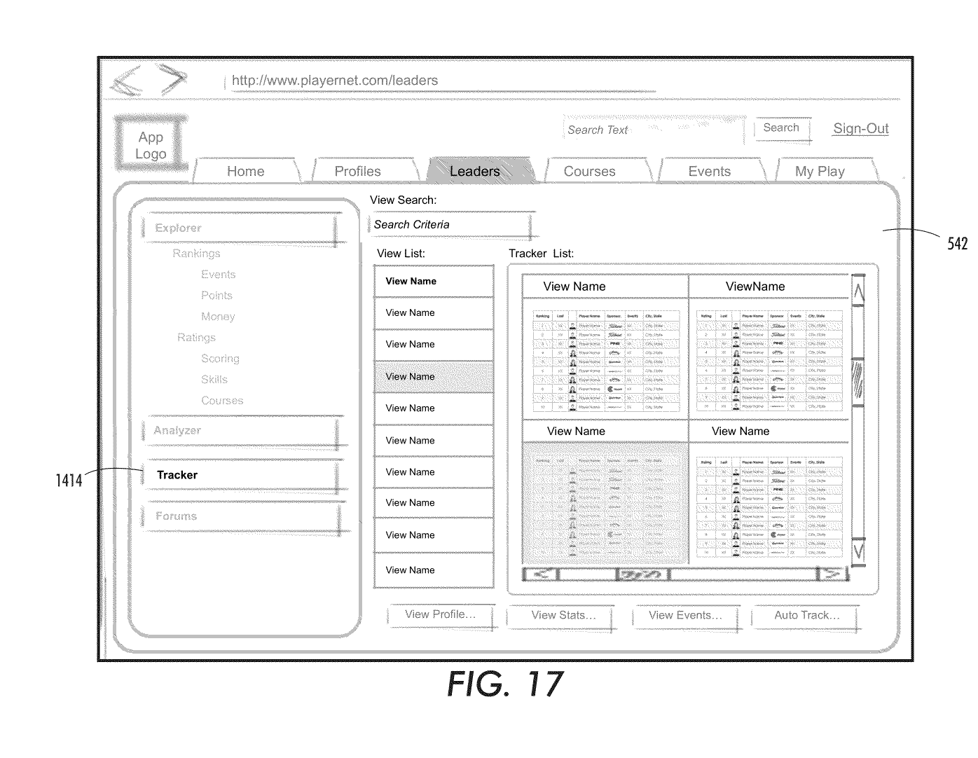

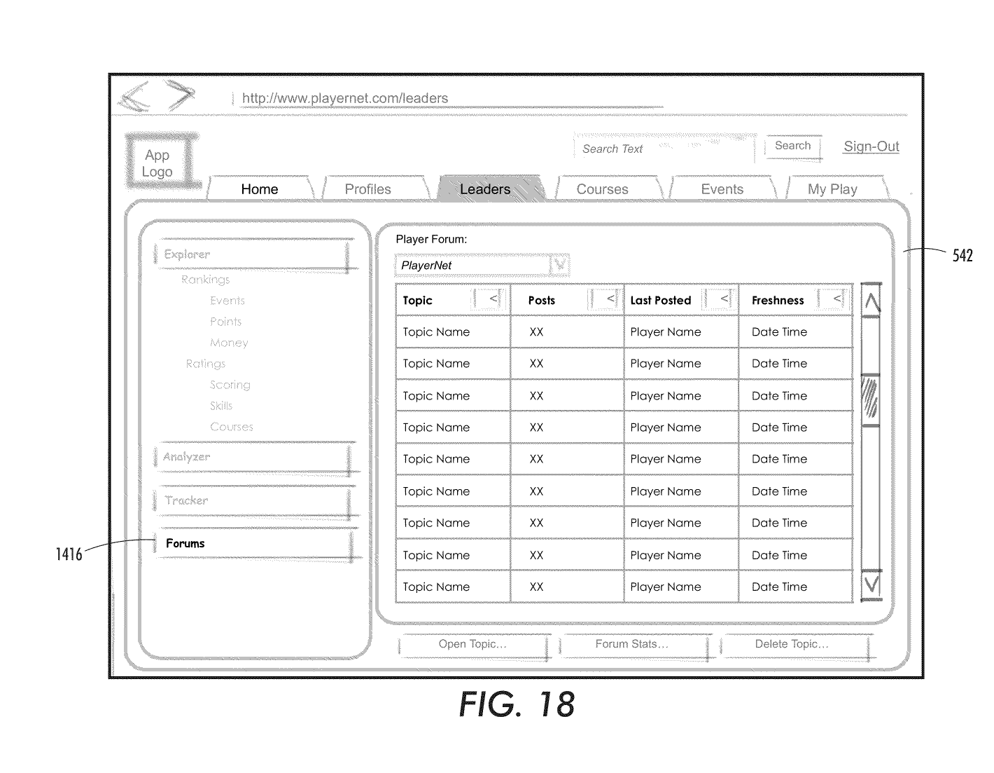

A user's selection of the tracker navigation button 1414 under the leader tab results in the display of tracked lists and leaders as illustrated in FIG. 17. FIG. 17 provides the function to actively (user initiates track and review) or proactively (system initiates track and notifies user to review) follow players and events in the network. Tracking can be manual, when user wants to open a tracking interface, and auto-tracking (e.g., button 1250) enables tracking to provide updates based upon criteria input by a user. Briefly referring to FIG. 18, the display is another method of accessing the discussion forums as described previously. As this is under the leader tab, the default forum being displayed is the leader forum, but as in the other forum interfaces, the user can alter the selected forum to be displayed.

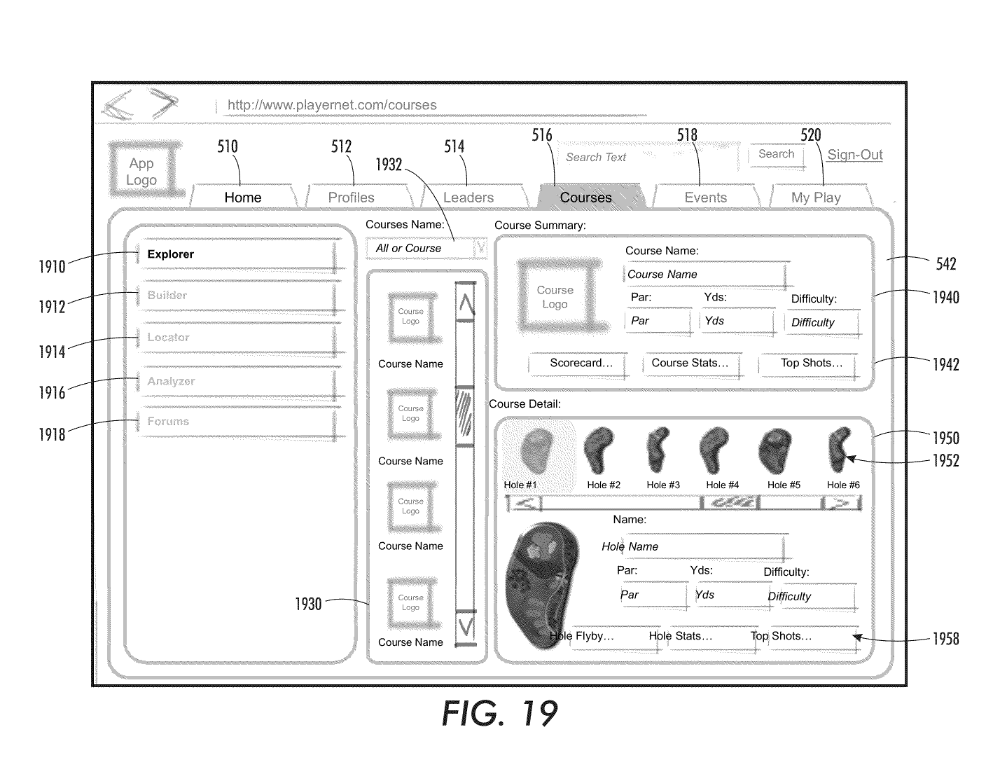

Attention is now turned to FIGS. 19-23, which provide various interfaces related to courses that may be “played” or accessed via LinksPlay. Again the navigation buttons or links 1910-1918 are employed to access different displays related to the courses under tab 516. Under the explorer link 1910, the display in region 542 is updated to enable a user to select one of a plurality of courses represented in scrollable list 1930, or in a course name search via region 1932. Once a course has been selected, its information is depicted in the fields of window 1940, and the user may then select one of the buttons 1942 to view a scorecard, course statistics (e.g., course difficulty, ranking of most difficult holes, how many players play per week, etc) or top shots (presenting a video view of top shots played on the course, such as holes-in-one, driving greens, etc.). The course's individual holes are also represented by individual thumbnails or iconic representations along the scrollable region 1952 in window 1950. By scrolling to and selecting a particular hole, the user may then access information related to the course (or simulator information for the course) to see the hole details or, via selection of one of the buttons 1958, have a flyby video presented, see hole statistics from players, or see streaming video of top shots on the hole. With respect to the flyby video, selection of the Hole Flyby button or link is anticipated to create a new window or pop-up that allows a user to not only “fly” over a particular hole, from tee to green, but may also include the ability to control the video, as well as possibly being able to select locations on a hole and to permit a user to see different views from the selected position (e.g., as in a street view type function on Google® maps)

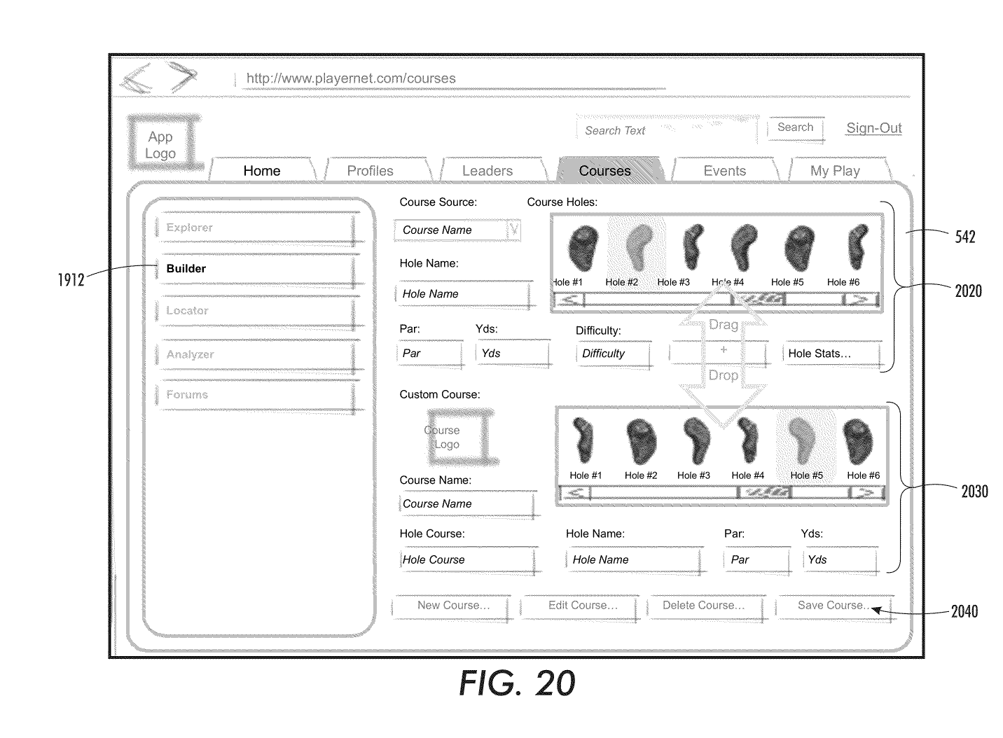

Turning next to FIG. 20, the course builder functionality of LinksPlay is illustrated in this display interface, where a user is permitted to construct or customize a course that can then be loaded and played on the simulator. Once the builder navigation link is selected the user is presented with a hole selection interface in region 2020, where the user may select a hole and then drag-drop (see gray arrow) the hole into a custom course interface in region 2030. By doing so, the user can build or customize a course using holes from various courses. It may also be possible to customize particular holes, for example, by changing pin locations, by reversing the orientation (dog-leg left changed to right), altering the distance (scaling the distance to a defined distance or par), etc. Buttons 2040 are also provided so that the user can start a new course, edit an existing course, delete a course and save a newly constructed course. It will be further appreciated that the courses constructed by a user may be kept private to the user or may be shared with defined groups or all LinksPlay players.

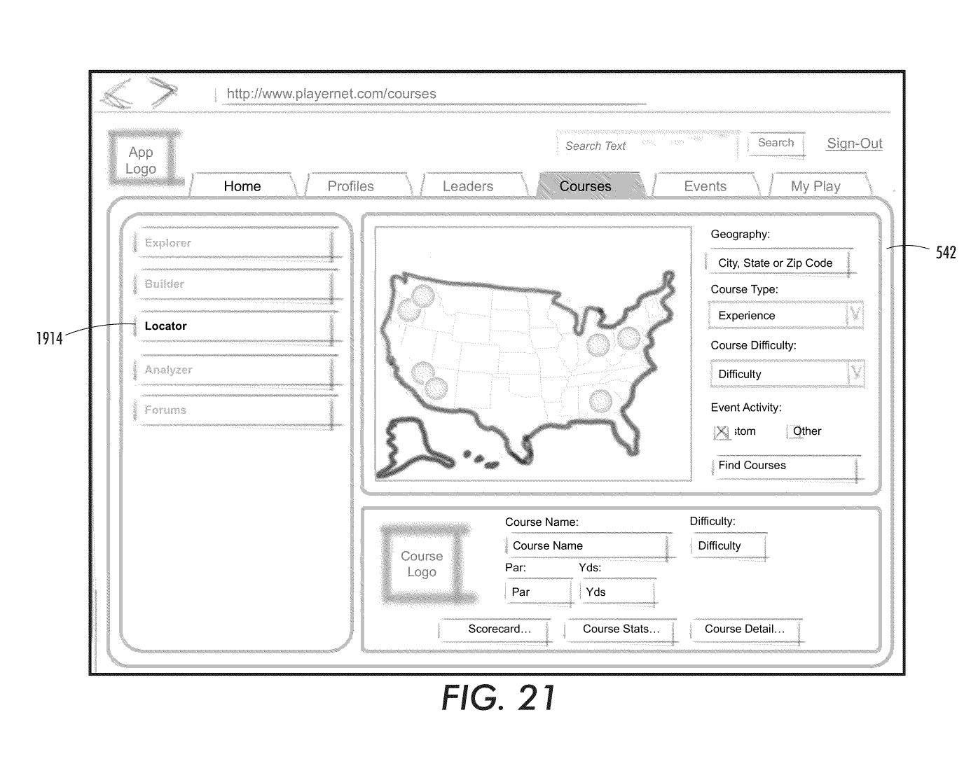

Referring briefly to FIG. 21, depicted therein is a locator function similar to that described in prior tabs. In this figure the locator button 1914 results in the display of actual (real-world) courses for which the simulator(s) has simulations available. In other words, the interface provides, again in region 542, the ability to search and view, both on a map and in text display fields, the location and details of actual golf courses. In this manner a user might wish to search out and play one or more courses on the simulator before visiting a region on vacation and actually playing the courses. Such a feature is believed to be an advantage of having a simulated environment capable of providing realistic and accurate representation of at least popular courses. A similar feature might provide some simulators with local course simulations so that users can practice on their home course during the winter or rainy seasons when the course may not be available.

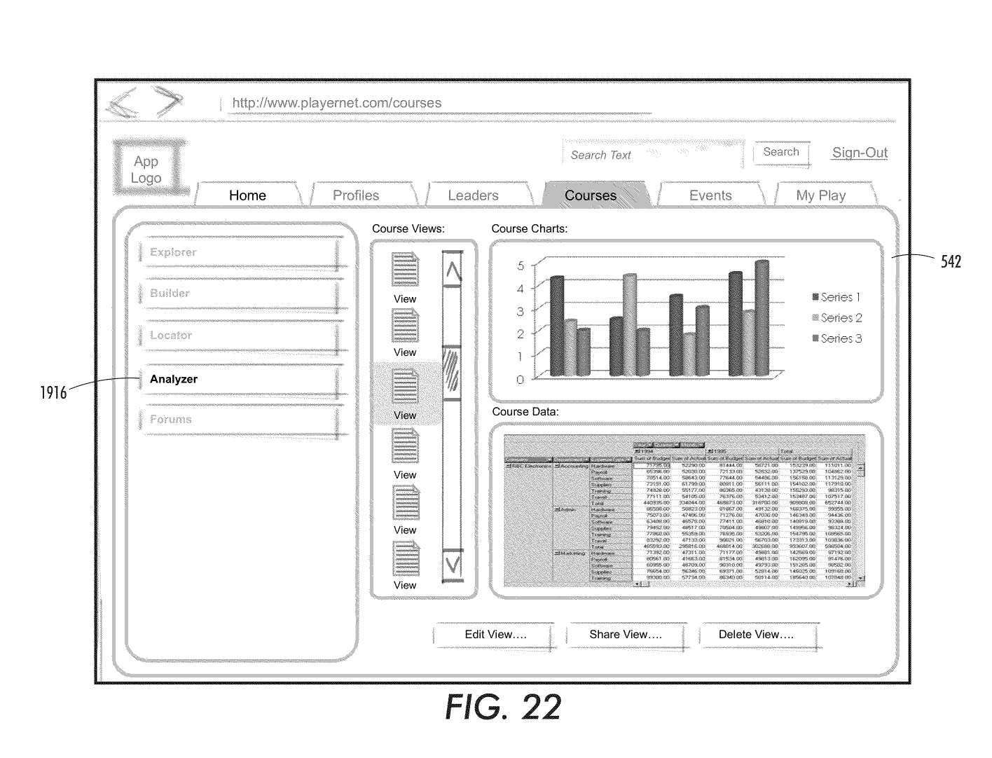

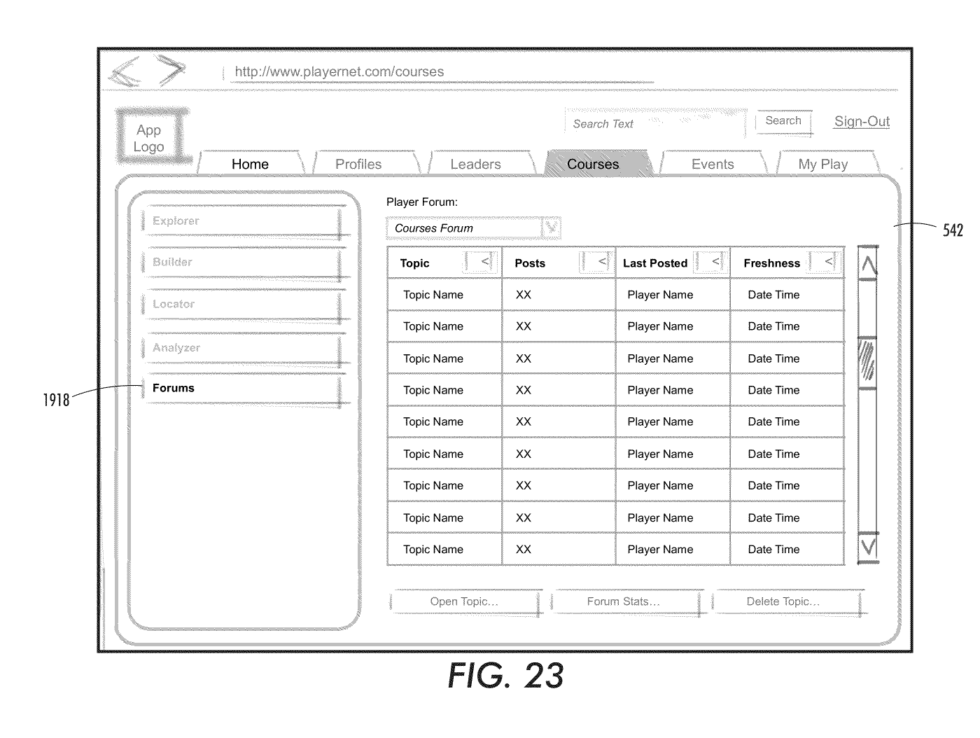

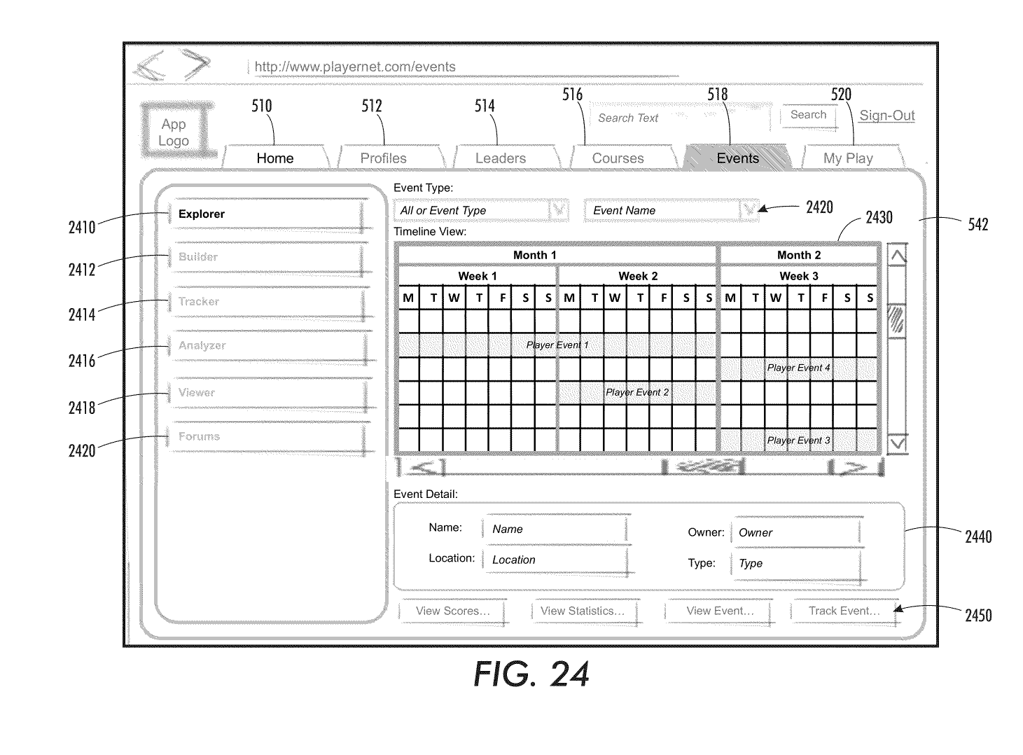

As represented by FIGS. 22 and 23, the analyzer and forums navigation links again provide access to information related to the courses. In the analyzed interface of FIG. 22, the course chart and data information in region 542 may be used to obtain an overview of course information. And, as previously described, the forums interface depicted in FIG. 23 will provide an entry point into the LinksPlay forums that are related to discussions of particular courses or course information.

As described relative to FIGS. 19-23 above, the LinksPlay system will facilitate various features related to the course or venue, including: venue previewing (see Hole Flyby button, FIG. 19), venue replaying and venue creation (e.g., builder function, FIGS. 19-20).

Referring now to FIGS. 24-31, various features and functions of LinksPlay relating to user events are illustrated. As noted previously, the term events has been generally employed in this description to represent any player activity that involves interaction with a simulator. Thus the events tabs includes various features that allow a user to view events that he/she may have selected to participate in, build or design events, track events, analyze events, view events and discuss events in the on-line forums. As seen in FIGS. 24-31 player events under tab 518 enable players, spectators and even advertisers a real-time, interactive window into current, future and past player events conducted within (or recorded in) the LinksPlay network. The events feature enables players, sponsors and advertisers to design and “run” events that can represent various single-player and multi-player golf scenarios from the simplest to the most complex. Player event construction assures that the player is in complete control of the player experience providing uniformity and consistency of play between participants that is independent of time and location.

More specifically, referring to FIG. 24 for example, the event explorer allows the players, spectators and advertisers to view and explore all events within the network, either in a live view (upcoming or ongoing) or previously completed events. In region 542, the event timeline 2430 provides a scrollable (up-down and/or left-right) view of the various events that correspond to the event type/name the user has entered in the field(s) 2440 above. As will be appreciated the events can be limited to those the user is participating in, those within a particular player group or location or other parameters. It will also be appreciated that various shading or color-coding means may be employed to distinguish between the types of events that may be displayed in the calendar view in timeline 2430. Selection of an event in the timeline/calendar window till result in the details of the event being displayed in window 2440, including such information as the name, location, owner and type of event. Moreover, buttons 2450 may be used to view various information (scores, statistics, type, etc.) for an event. The track event button may be used to add the event to a list of tracked events as discussed relative to the event tracker interface below.

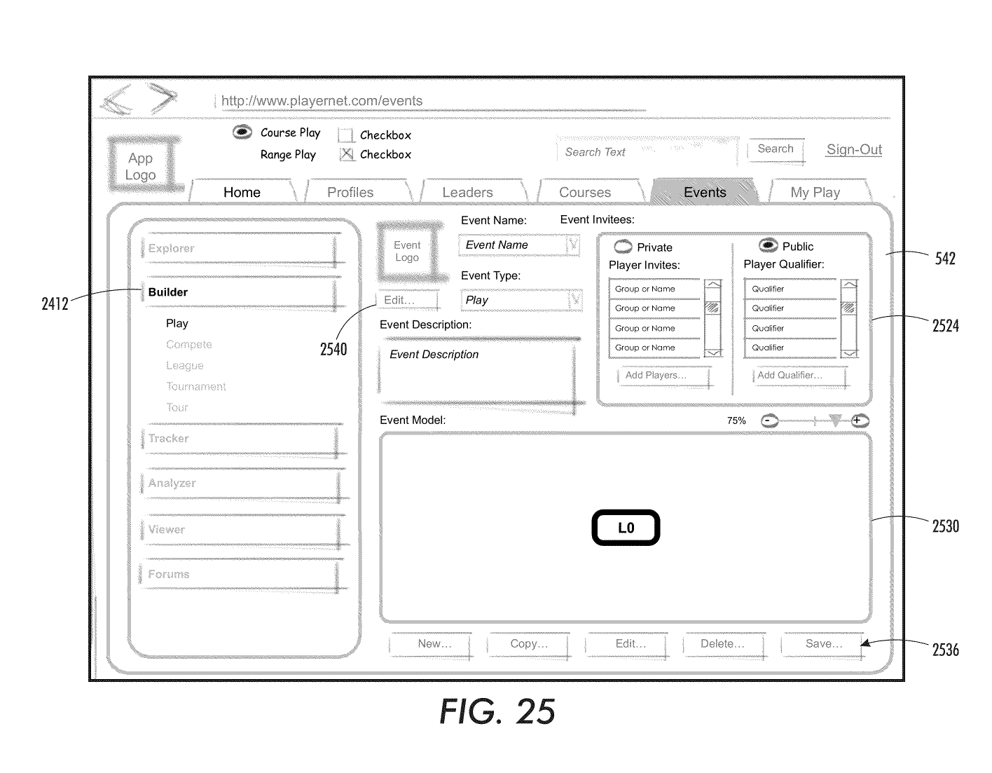

Turning next to the event builder interface represented by FIG. 25, depicted therein is an exemplary interface for the LinksPlay features that will enable players, sponsors and advertisers to define new, or copy and modify pre-existing events for individual play, as well as league, tournament or even tour-like events, or multiple tournaments, all within a common event construct. Also various event levels provide support for the migration from an entry level to more complex events, where each level largely defines the specific play format, course and hole selections, timeframe, settings and player qualifying rules to advance.

Builder interface under navigation link 2412 is further broken down into play, compete, league, tournament and tour functionality as illustrated, for example, in FIG. 25. Under the play function, region 542 of the interface includes information relative to a particular invitation to play with one or more other players. A logo and mane may be entered for the event, along with a description. This information may also be edited (button 2540) at a later time. In window 2524, the user is prompted to identify the event as a private (limited invitees) or public event (all or qualifying invitees), and to establish relevant criteria for a player to be invited. In this manner, the event may be controlled to a particular size, location, group or individuals, etc. The event model found in window 2530 provides an overview of the event's organization or structure. This window would be scalable using the scale slide immediately above the window. For the depicted play event, no particular structure is indicated, so the model is simplistic as illustrated, showing only a single player “L0.”, where L0 indicates Level 0 or base for the event. Lastly, buttons 2536 again permit the user to edit, save, delete and copy events as well as save that which has been modified or created.

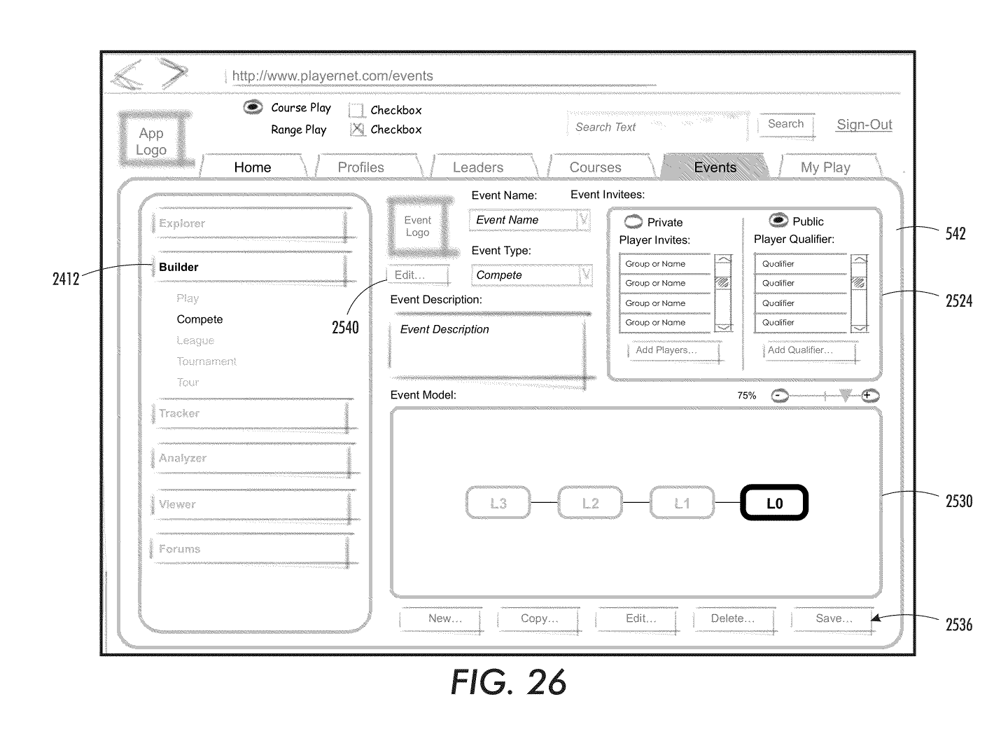

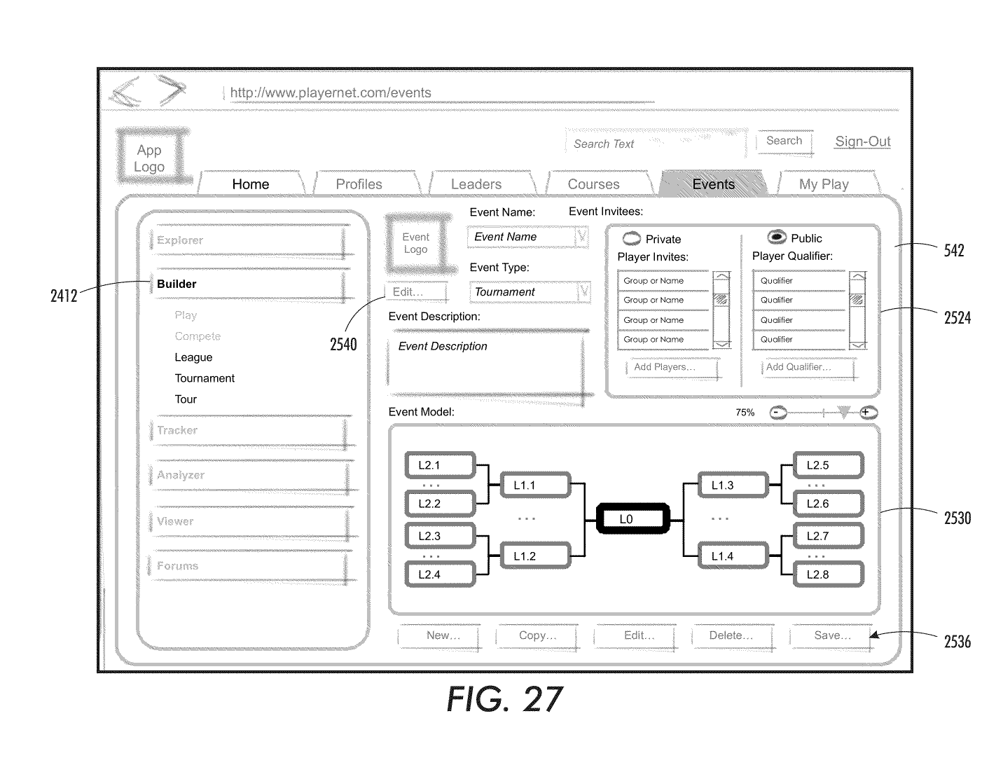

Turning next to the compete interface under event builder, as represented by FIG. 26, depicted in that interface are similar structures to those of FIG. 25, but where a plurality of players (e.g., a foursome) are to be scheduled to compete. In setting up such an event the user is inviting others (“L0-L3” as illustrated in window 2530) to participate in the event where they would compete against one another. Referring also to the illustration of FIG. 27, depicted therein is a tournament building interface where, as illustrated in the event model window 2530, a multiplayer or team event such as a tournament has been designed. It is further contemplated that different levels of the tournament may have different qualification requirements and that such requirements may be entered in association with the tournament level selected in window 2530.

In a manner similar to those described relative to the previous several figures, FIG. 27 may also include models representing a league or similar event where players are invited from a group on LinksPlay and the league play requires one or more rounds to be played per week and where standings or rankings are produced as a result of individual golfers' performance over a series of successive rounds. As will be appreciated the system may include similar models and constructs for tours, essentially a series of tournaments, and where player's performance is tracked and aggregated over a plurality of tournaments to determine a tour champion, etc.

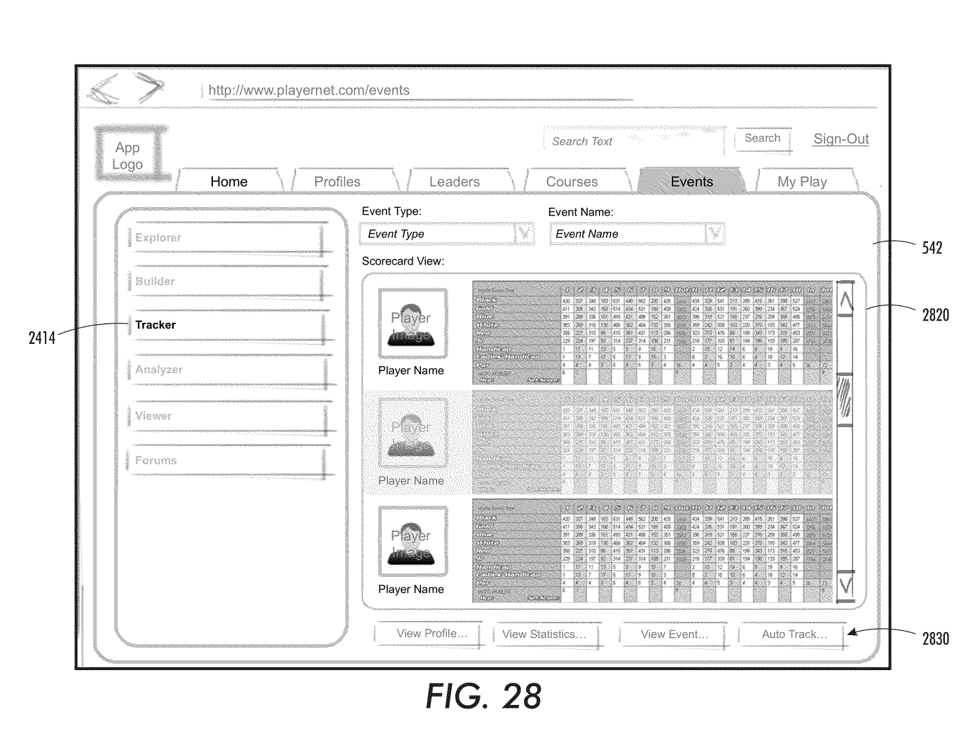

In the event tracking interface depicted in FIG. 28, users may track the entries and performance of players in specific events. By selecting or entering an event type and/or name in the fields at the top of region 542, the user will be provided, in window 2820 with a scrollable listing of players that have accepted an invitation to or are participating in the event. As in earlier tracker interfaces, if a user selects a player from the list in window 2820, they may then select one of the buttons at 2830 to view or navigate to further information about the player (profile, statistics), the event or event add the event to be “auto-tracked” so that the user is notified of changes relative to the event (e.g., results, players, whether or not I am actually in or out of the event, etc.).

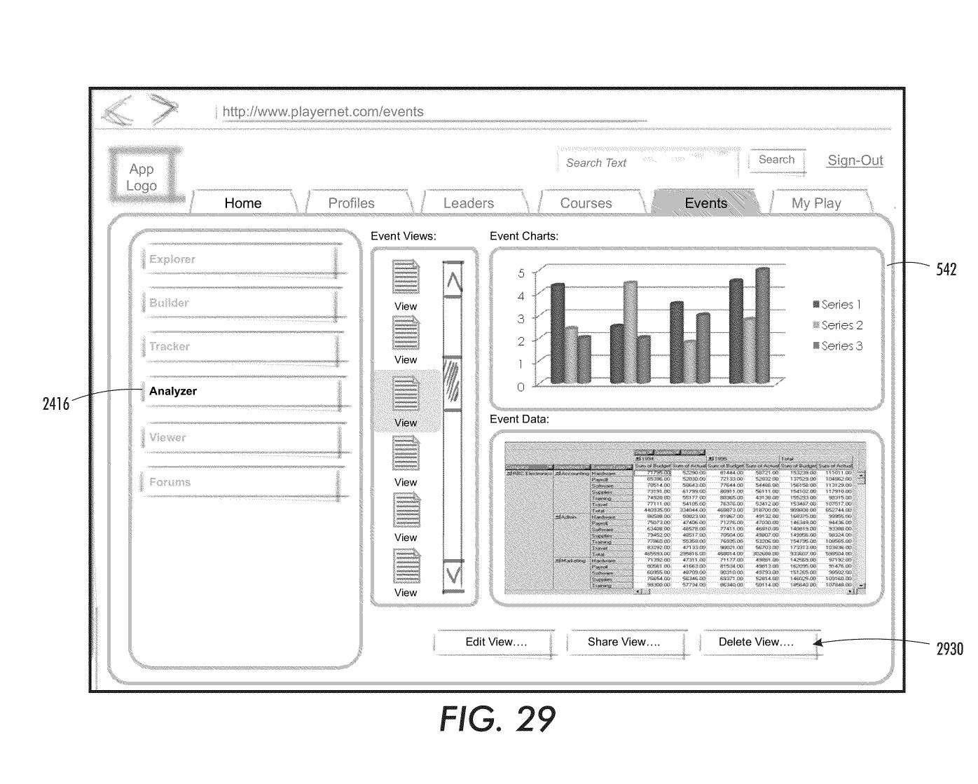

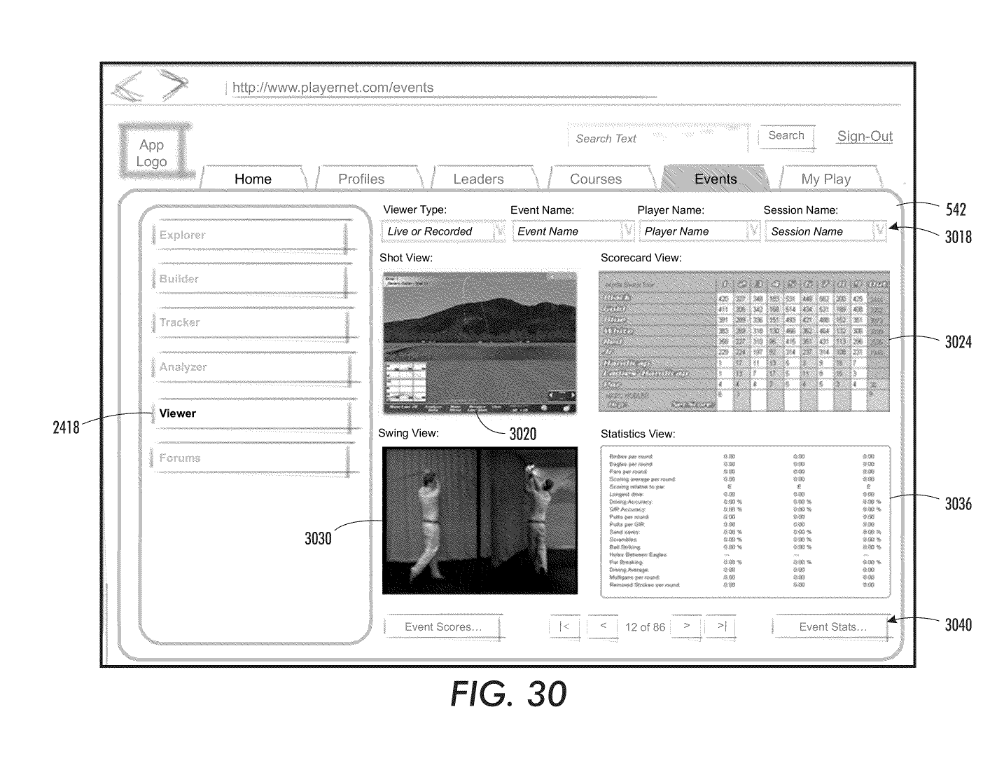

Also considering LinksPlay's event analyzer function, as represented in FIG. 29, the system enables users, sponsors and advertisers to not only view events through standardized event views, but to explore events by modifying existing views or creating completely new views and then sharing the views or submitting the views for promotion as standardized views within the network. As depicted in region 542, various views are available for selection and control the type of information presented in the chart and data regions of the event windows. As represented by buttons 2930, the views may be edited and customized for particular purposes of event types. Also referring to FIG. 30, depicted therein is an exemplary view, in region 542, which would have been constructed and stored using the event analyzer feature depicted in FIG. 30. As will be appreciated, the control of the analysis, templates, etc. is facilitated through the LinksPlay database as described earlier, such that access to events and views is not limited to those having access to a particular computer or local network, but (assuming appropriate permission/authorization) to a wide number of users—which includes golfers, sponsors, advertisers, as well as others.

In FIG. 30, in response to user selection or entry of information for fields 3018, the display in region 542 is updated to illustrate data/information related to the event in the view format selected. As the example indicates, the view may include a particular shot video 3020 (e.g., video of the resultant simulated shot), a scorecard 3024 showing information about the course being played, a swing view window 3030 showing streaming video of the golfer swinging, and statistical data in window 3036. The buttons along the bottom facilitate further navigation by providing direct access to score or statistics, and further allow the user to move through pages that, at least in the example depicted, would permit viewing of other players that were or are participating in the event.

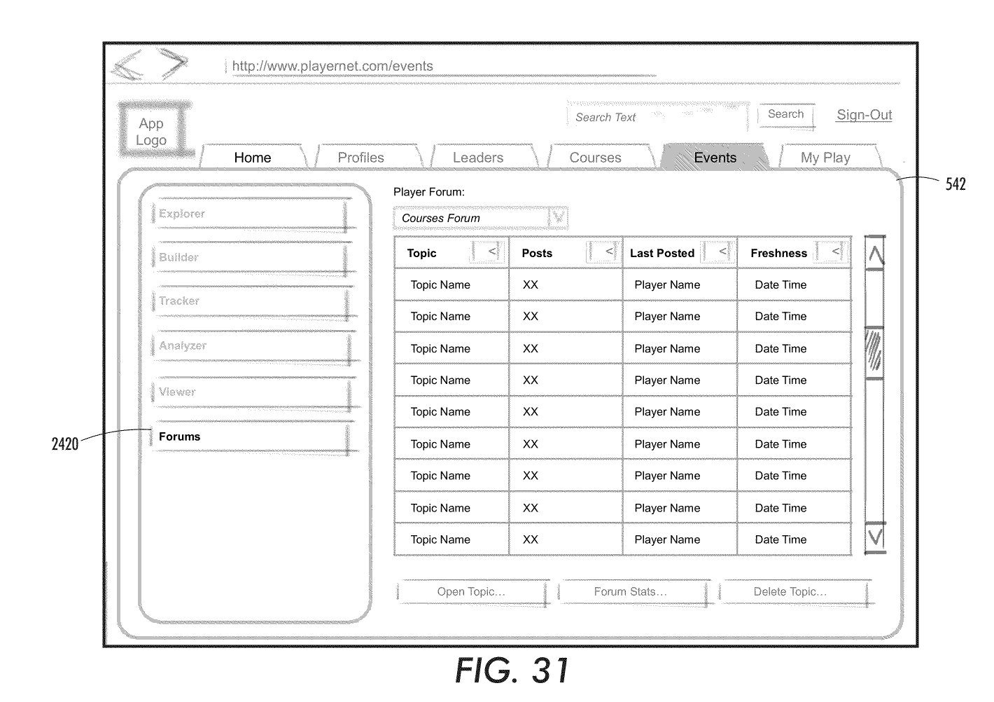

Briefly turning to FIG. 30, depicted therein is an event forum interface where the user is directed to the discussion forum, under event-related topics upon selection of navigation link 2420. The various aspects of the forum illustrated in region 542 of FIG. 31 have been previously described and in this case similarly provide a platform for players, sponsors and advertisers to discuss various aspects of an event or another topic.

In view of the above description relative to LinksPlay events, it is believed that various features and functions will be enabled by the system and methods disclosed. Events will be location and time independent, which facilitates participation by others. Moreover, the users of the LinksPlay system will be permitted to create events and thereby enable dynamic invitations to which more users can respond and thereby increase the use of the system and improved performance. The events also include dynamic qualifiers that enable participants to not only design events with qualifying requirement but also to actively try to qualify by playing or performing in simulated golf environments. It is also possible that LinksPlay features and functions may be extended to actual golf course situations where data is collected on a player's actual performance as well. As represented in FIGS. 25-27, described above, the system further permits the design or modeling of events, and the subsequent tracking and view of the events. As noted the viewing (viewer link 2418, FIG. 30) would permit live viewing of players' performance not only in real-time (were one to view while the player were playing), but also in a recorded viewing mode where one could watch a player's performance from an earlier time.

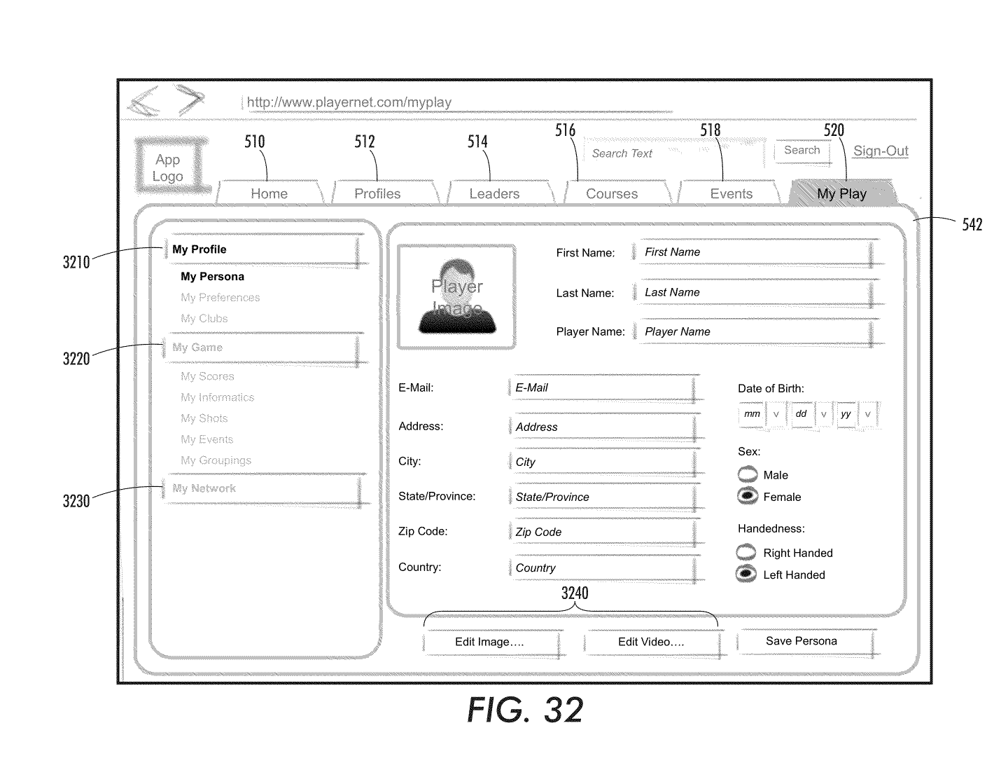

Considering next, FIGS. 32-40, depicted therein are exemplary interface representations associated with the My Play tab 520, which in general provide the player or user with the ability to control his or her experience and to analyze the information that will be collected relative to their performance in various events. Player profiles is a usage method that not only enables players, spectators and advertisers a real-time, interactive window into the player profiles within the network, but will enable the players to manage their own personal profiles on-line in advance of on-site (e.g. simulator) play, allowing the system to auto-configure the simulator player settings (based upon stored profile data) without player intervention. Today, every simulator experience requires manual data entry to setup the player prior to play and reentry of such data for each and every simulator that does not already have the player's profile setup. The problem is compounded when the player plays in different locations with different simulators. There is no ability for the player to enrich or express their persona on-line beyond just the player names if at all. In LinksPlay the players will manage their on-line profiles in one place and the information will be automatically referenced wherever they play in the network and whenever their profiles are viewed or explored on the LinksPlay network (e.g., Internet). Lastly, player profiles greatly increase the quality of the profile information, a critical foundation for enabling high quality player informatics.

Player profiles are managed using the My Play tab and will provide much more than just basic player settings. Considering FIG. 32, for example, the My Persona interface, navigation button 3210, will capture not only player demographics in the data fields depicted in region 524 but enables the Player to be expressive in how their “persona” is represented to anyone on-line, including a player nickname, image and video (buttons 3240). The various data fields that are illustrated in FIG. 32 are illustrative, and it will be appreciated that in addition to the information indicated other information may be included in a player's profile. Moreover, the data may be stored in the database 220 as described above and may be subsequently revised or edited by the player.

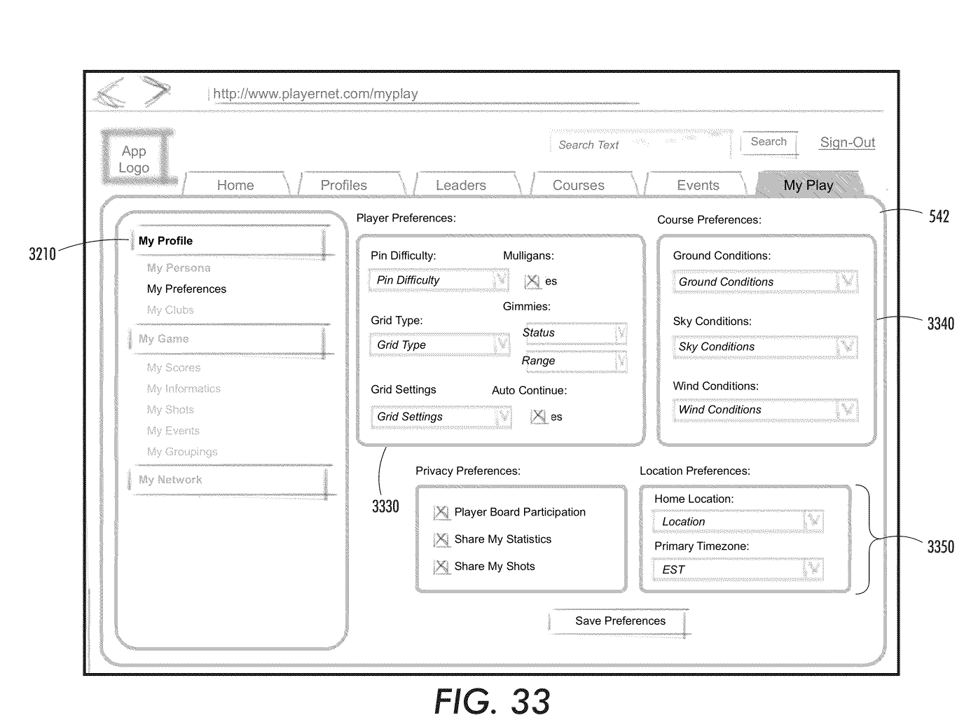

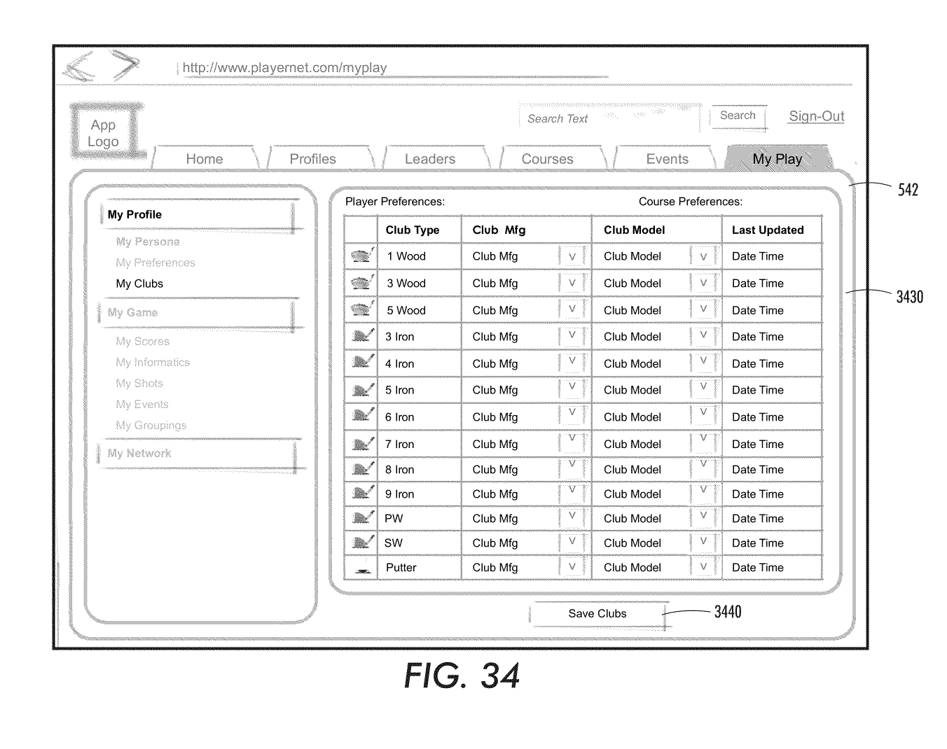

Turning to the My Preferences interface, as depicted in FIG. 33, the interface will capture the preferred player settings across player events, avoiding the need for a player to reenter player settings for each every session or event, in each and every simulator. As illustrated, the player's preferences may include not only player preferences (3330) largely in relation to the simulator experience but also preferences related to courses (3340). As previously noted, the actions and information of players is public by default as indicated by the preferences indicated in windows 3350. The user will also be asked to input information relative to his or her clubs as illustrated in FIG. 34. The My Clubs interface of FIG. 34 will provide an editable list 3430 in region 542, where the user is prompted to enter each of the clubs in his or her bag. The intent of this is to include all clubs that may be used in the simulator. This will permit the user to easily select the club during play in the simulator, or possibly to employ one or more identification technologies (e.g., photo analysis, RFID tags, etc.) to have the simulator auto-identify the club selected by a user of the simulator. Button 3440 permits the player to save his/her clubs once entered in the list 3430. My Clubs will capture the exact specification of each and every club in the player's bag, and may be critically important in building player informatics for each existing club, demo club or future club added the bag. The club data, like the profile data, will be stored in database 220 and will also be the underlying data in enabling the club selector system method and product play monetization method.

Player Profiles is also a critical building block in establishing the players' avatars or virtual alter egos on-line, acting as a powerful interpersonal medium between the player and other players, spectators and advertisers. Player profiles will be public by default, meaning that a profile can be viewed and explored by others using the LinksPlay system as previously described. For example, as previously described: Profile Explore (FIG. 9), will enable players, spectators and advertisers to better explore the players in the network by persona, demographic and geography, with the ability to even chat with players in the network; Profile Analyzer (FIG. 10) will enable players, spectators and advertisers to not only view profiles through standardized profile views, but to explore profiles by modifying existing views or creating completely new views and then sharing the views or submitting the views for promotion as standardized views; Profile Locator (FIG. 11) will enable players to find other players to play independent of time and location, enabling new and social and competitive groups and communities to be formed organically over time; Profile Tracker (FIG. 12) will enable players, spectators and advertisers actively (user initiates track and review) or proactively (system initiatives track and notifies user to review) follow players in the network; and Profile Forums (FIG. 13) will enable players, spectators and advertisers a forum for player discussions.

Furthermore, Player Profiles will also give advertisers the ability to directly evaluate current or future player sponsorships, an important element of the actor tagging monetization method as described above. In many ways, Player Profiles will provide unparalleled insight into the very people, behavior or specific demographic that the advertiser is trying to reach for their product or service.

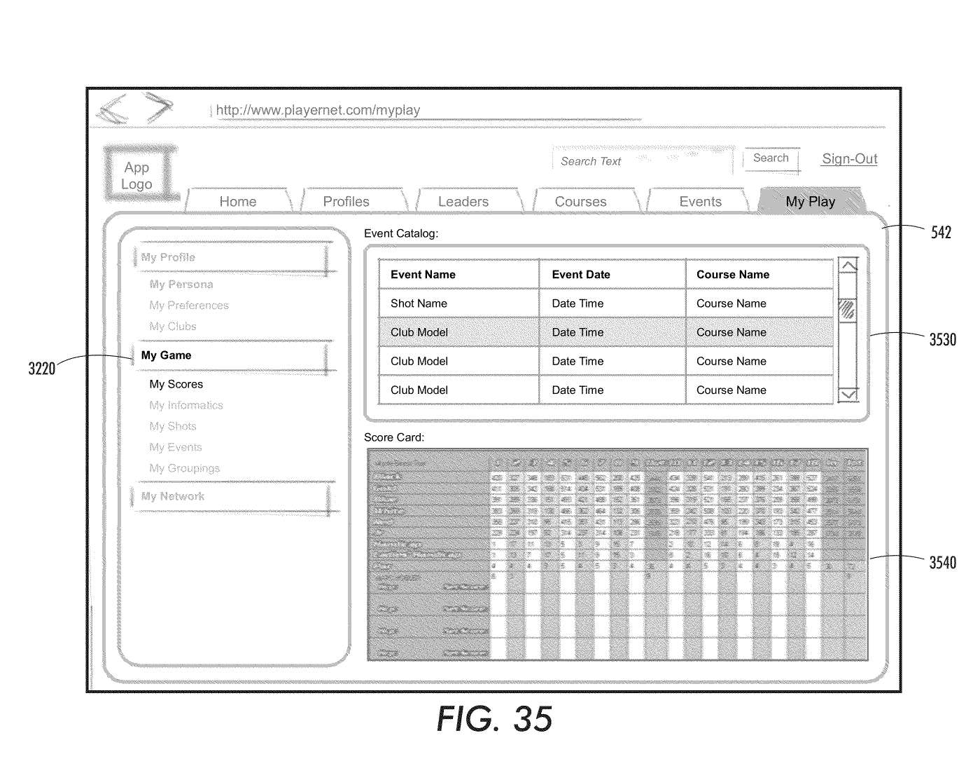

FIGS. 35-39 are specifically directed to representing information and data relative to the My Game portion of the My Play tab. In general, player informatics is a usage method that will not only enable players, spectators and advertisers a real-time, interactive window into the top performing players in the network through player leaders, but provides each player unequalled performance insights as their game develops and evolves over time. Today, the only performance insight a player gets from a golf simulator is during actual play, and even that insight is simply a flash of high-level performance statistics between shots. While a few golf simulator providers provide basic, high-level performance statistics on-line, it is limited to only the player's last session and is presented in static views with little if any ability to explore the performance insights and trends across multiple player sessions, settings and conditions. Player informatics will empower the players, spectators and advertisers to analyze and discover their own insights through the following:
Profile Analyzer—live analysis of public profile statistics as the player network grows and evolves over time, such as active players by time, senior players by geography, skill players per geography, etc
Leader Analyzer—live analysis of public leader statistics as the player network grows and evolves over time, top 10 in driving distance by geography, top five ranking by time, etc
Course Analyzer—live analysis of public course and hole statistics as the player network grows and evolves over time, such as course popularity ratings and hole difficulty ratings over time, etc.
Event Analyzer—live analysis of public event statistics as the player network grows and evolves over time, such as event participation rates per geography, event organizers over time, etc.
My Informatics—analysis of personal performance statistics as the player grows and evolves over time, such as average driving distance by time, green hit in regulation by time, scoring by course, etc.

Player Informatics utilizes a set of visual, interactive and flexible analysis tools that empower the Players, Spectators and Advertisers to easily explore and analyze all user relevant metrics (measures) from multiple perspectives (dimensions) within the player network. Corporate will create a standardized set of views for Profile Analyzer, Leader Analyzer, Course Analyzer and Event Analyzer as well as standardized set of performance views for My Informatics. Views can then be easily modified through basic filtering and sorting and over time, completely new views can be created from scratch and submitted to Corporate for approval as new standardized views. In addition, Players can collaborate with other Players in the network by sharing views and insights.

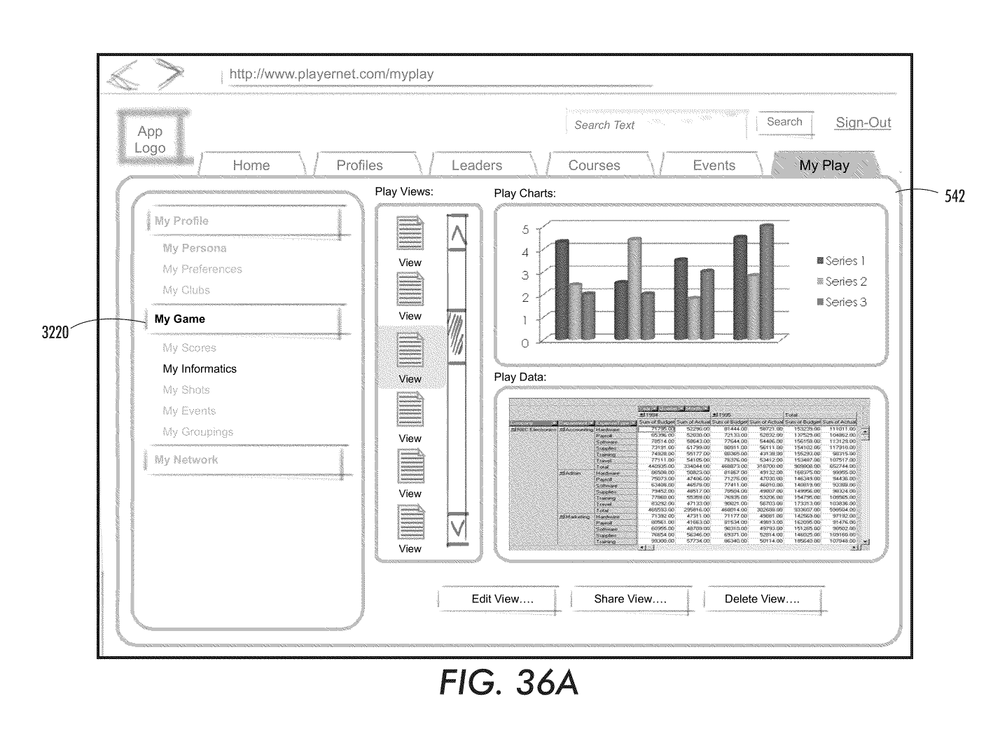

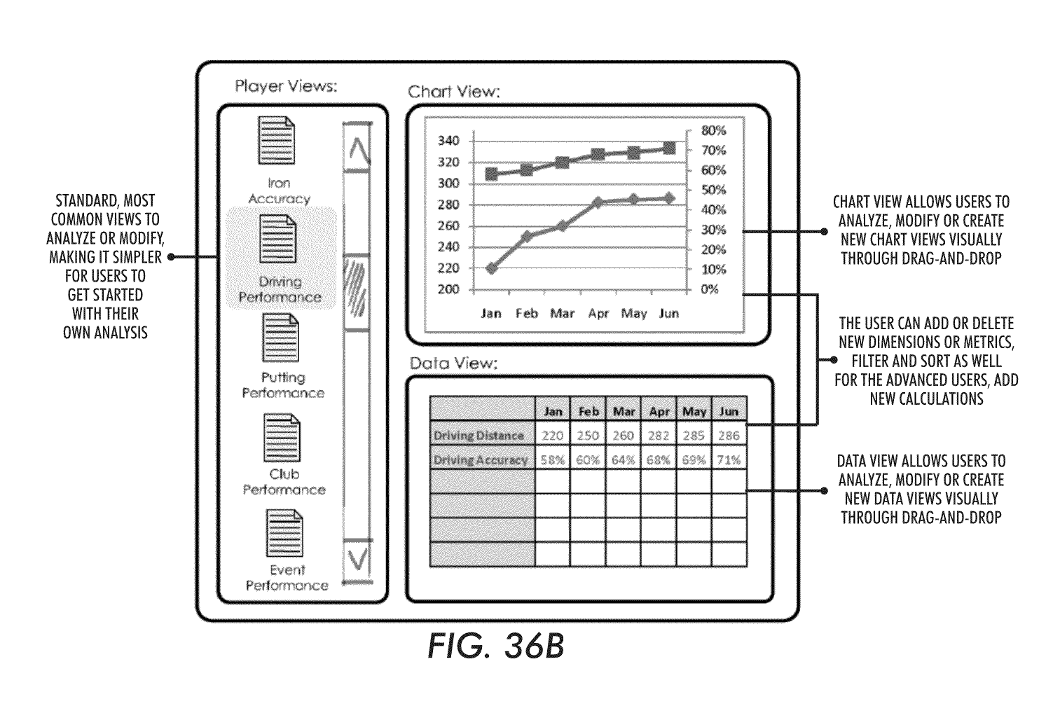

Turning to FIG. 35, the My Games navigation link and in particular My Scores sub-link will provide a listing of events for the player in window 3530 and an associated scorecard in window 3540 that corresponds to the event selected in window 3530. And, as illustrated in FIG. 36, there is shown an exemplary interface for a player to create/edit the views associated with their particular events or play. As in prior interfaces, the various forms of information, as determined by the user's selection of a view, will determine what data will be displayed in the charts and data windows in region 542.

Using a simple, visual and interactive user interface, multi-dimensional analysis empowers the user to easily explore and analyze metrics (measures) from one or more perspectives (dimensions). For example, players can look at scoring trends by course, by hole over the last week, month or season in practice or as part of on-line tournament. The player can track shot distance and accuracy over time (e.g., see FIG. 36B) as result of increased repetition, different club and/or golf instruction or as part of on-line skills contests. Scoring and statistics can be easily compared locally, regionally and globally in the form of leader boards. New data or visual views can be easily created and shared by the user, specifically by selecting, filtering and sorting the information using drag-and-drop or creating completely new views by selecting new metrics or perspectives, all pre-defined within a given cube (see e.g., FIG. 2C). Relative to the view of information, it will be the cubes (FIG. 2C) that define the limits of users analysis as contemplated in the various embodiments. In other words, every possible combination of perspectives (dimensions) and metrics (measures) can be explored by the user (e.g., golfer, advertiser, and administrator) and everything will be available over time for trending analysis.

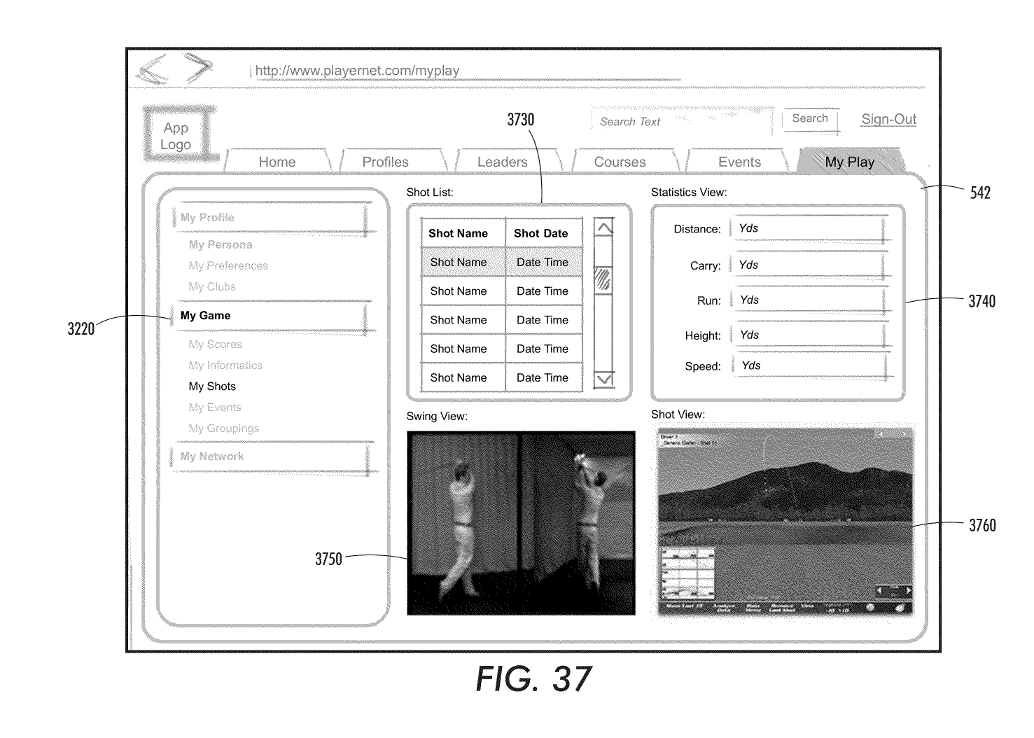

Considering FIG. 37, depicted therein is an example of a My Shots interface that will allow a user to review the stored data, including video, for each shot the player has taken in the LinksPlay system. The shot list for the user is illustrated in window 3730, and may be further selected or indexed via other data such as course/hole, event, club used, etc. One a user has selected a shot it may be given a unique name for later identification. Selection also results in population of the other windows, including the statistics in window 3740, the swing video in window 3750 and a simulated shot view in window 3760. It will be appreciated that the video for window 3750 may be recorded steaming video, and that the video may be stored video or may be real-time recreation based upon simulator data (storage of shot data may be less memory intensive than storage of shot view video).

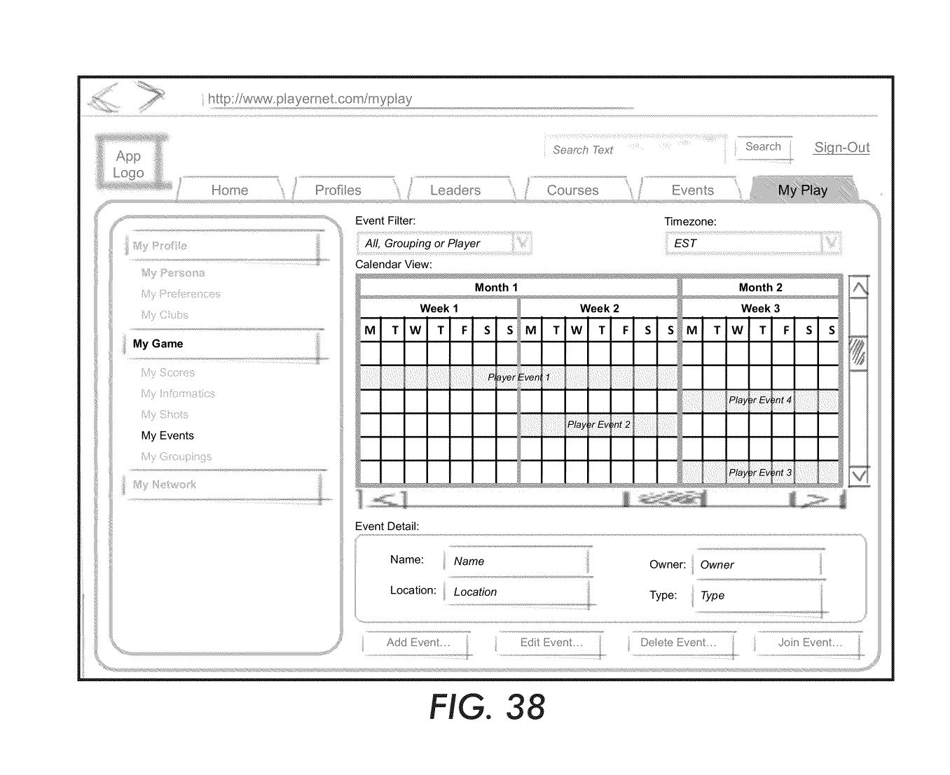

Turning next to FIG. 38, depicted therein is a calendar view of events in region 542, but this time the events will correspond to those in which the user has enrolled or signed-up for or has participated in. The functionality of the various aspects of the My Events interface is similar to that set forth above for FIG. 24 and has not been repeated here. It is also contemplated that the events calendar may include the ability to enter other golf or personal information on the calendar. It is further contemplated that scheduling, for example tee times at a local course, may be facilitated through the calendar as well.

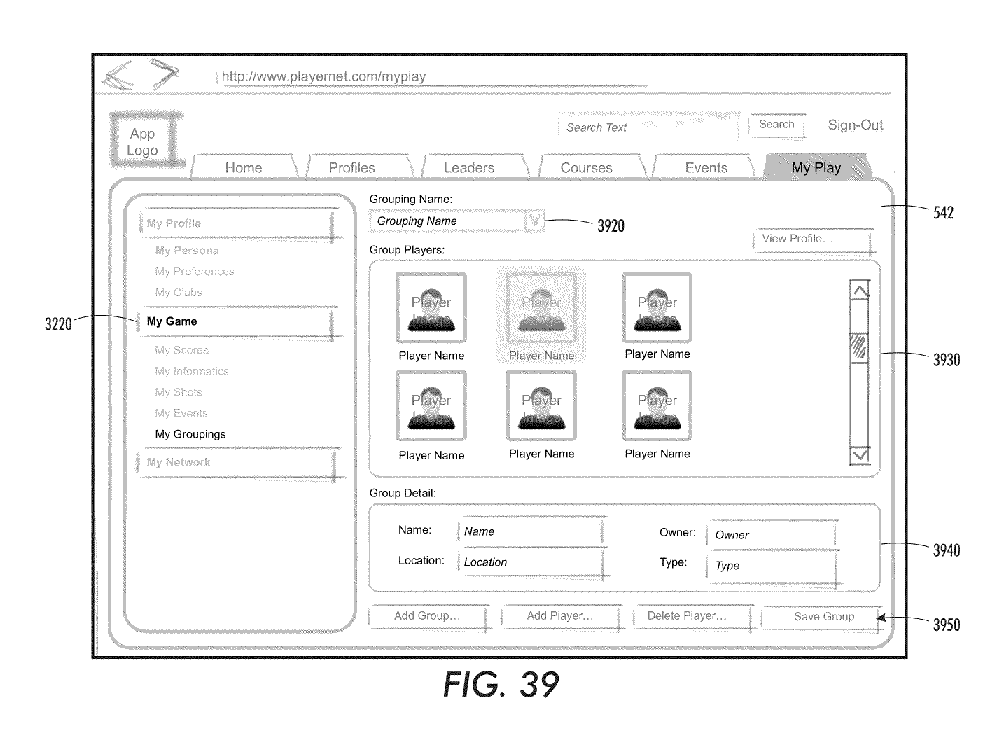

FIG. 39 is, again related to My Play tab 520 and My Game information, an illustration of a possible interface to enable a player to select, edit or review the various groups that he or she may belong to. Each group in which the player is a member would be listed in a drop-down menu bar 3920 in region 542. Upon selection of a group, the members of that group would be displayed in window 3930. Details for the selected group are also listed in window 3940, and buttons 3950 permit adding groups, editing groups, etc.

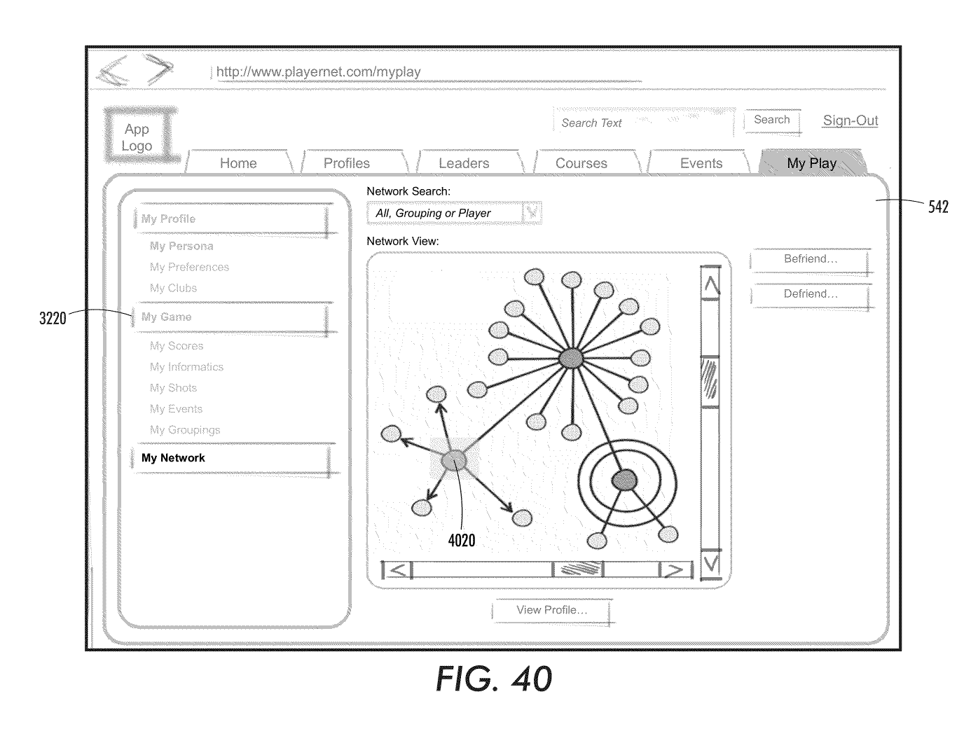

Now considering FIG. 40, the My Network interface is intended to provide a user 4020 with a graphical representation, in region 542 of the network that he or she is associated with other players or other player groups, associated with other player or other players, groups and so on.

The LinksPlay system also contemplates the ability to make awards or rewards available for player participation in events (performance based, usage based, etc.). In one scenario, the event sponsor(s) puts up a monetary or prize purse and define how it will be disbursed (e.g., top three players, top in each region or area, etc.). Such events may or may not have entry fee. In other events, part of the player's entry fee may go toward funding the purse for an event, and LinksPlay may reserve a portion as a service fee. It is further contemplated that the POS system of FIG. 2D will enable automated payments of entry fees from credit cards, PayPal and similar systems. Thus the award/reward aspect could be player-driven where the group agrees to pay for purse that is divided.

Wagering is a another option where outsiders such as spectators could actually wager on the performance of players in events themselves, and where a portion of wagers would similarly be used to fund the event purse and/or as a revenue stream for LinksPlay. While wagering may be limited by the regional laws, LinksPlay contemplates the access to and use of event information as being conducive to certain wagering opportunities.

As mentioned above, the Point of Sale (POS) capability indicated within the cloud in FIG. 2D contemplates various means by which users of the system may interact with the system to “pay for” various options or items. In one embodiment, a charge card and/or PayPal account information is provided by the user as part of their profile information and the system automatically provides for payment of entry fees, subscriptions, charges at local LinksPlay cafés, etc. via the pre-authorized account. It is further contemplated that vendors, or possibly even a LinksPlay “storefront” may enable the purchase of golf-related or other items via the user's account.

In an alternative to a cash or financial award or reward program such as described above, the LinksPlay system further contemplates the use of points for redemption. As alternative to cash rewards for events, “points” or tokens of some nature could be accumulated by players or other users, and the points could later be redeemed for direct purchase of merchandise or services, or to obtain discounts on such items. Players could acquire points based upon their participation or performance in various events (e.g., winning tournaments, playing most days per week, etc.). It is also conceivable that player's themselves could engage in transactions involving point amongst them. For example in a foursome, the players may all agree to pitch in 2-points for each hole and the winner of the hole gets all the points for that hole. The LinksPlay system may not only track the point transactions, but may also enable, as part of the event design itself, the player-initiated rewards.

It will be appreciated that several of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above and the following claims.

What is claimed is:

1. A method to facilitate the acquisition and sharing of information related to a golfer, comprising:
collecting and storing, in a memory associated with and accessible by a networked computer, personal information about the golfer;
collecting and storing, in the memory, performance data representative of the golfer's performance in at least one event associated with a simulated golf environment wherein said data collection and storage is automated and occurs without the golfer's intervention;
subsequently providing access to said memory and data to the golfer, including performing at least one analysis of the golfer's performance data and reporting a result of the at least one analysis performed; and
initiating, in response to a golfer's input, an event in which the golfer and at least one other golfer may participate, said event operating upon the collection of data in the memory.

2. The method of claim 1, further including providing access to said memory and data on a basis selected from the group consisting of:
subscription,
bidding, and
negotiation.

3. The method according to claim 1, wherein the memory includes a data repository and where at least a portion of the golfer's performance data is generated by a golf simulator.

4. The method according to claim 3, wherein golfers data is analyzed to determine at least one a plurality of metrics and where at least a portion of the golfer's performance data includes both current and trend data associated with the at least one performance metric.

5. The method of claim 4, wherein the golfer dynamically adjusts a display of the at least one performance metric.

6. The method according to claim 4, further including displaying to the golfer an advertisement as a function of at least a portion of the golfer's performance data.

7. The method according to claim 6 further including data tagging wherein a first level of revenue is collected as a result of the golfer acknowledging the displayed advertisement

8. The method according to claim 7, further including a purchasing transaction associated with the displayed advertisement, wherein the golfer's personal information is referenced for purposes relating to completion of the transaction.

9. The method according to claim 1, further including event tagging wherein an advertiser bids for rights to host the event.

10. The method according to claim 1, further including advertiser bidding wherein a plurality of advertisers bid for on-line advertising time associated with real-time display in the simulated golf environment.

11. The method according to claim 1, further including conducting a search in said data collection for at least one characteristic of the at least one other golfer, wherein the search results in the display of at least one other golfer matching the criteria and where a user interface depicts a combination of personal information and performance information for the at least one other golfer.

12. The method according to claim 11, wherein the at least one other golfer is invited to play in the event.

13. The method according to claim 1, further including collecting and storing video data depicting a golfer's performance, said video data being associated with the golfer's performance data.

14. The method according to claim 1, further including course building wherein a user constructs a course that is loaded into memory accessible by and is used in the simulated golf environment.

15. The method according to claim 1, further including providing an interface by which at least one spectator views the performance of the golfer.

16. The method according to claim 1, further including an event builder interface, said interface providing for the creation and editing of an event from the group consisting of: Individual play, one-time competition, league play, tournament play, and tour play.

17. A system for facilitating the acquisition and sharing of information related to a golfer, comprising:
a simulator for providing a simulated golf environment for at least one golfer;
an application rich cloud, including at least one networked computer and associated memory that serves to enable global access to various processes, said cloud facilitating the storage of data generated by the simulator when used by the golfer; and
a plurality of computer platforms having access to said application rich cloud, whereby the golfer accesses the data generated by the simulator and stored therein.

18. The system of claim 17, wherein a display associated with at least one of the simulator and the computer platforms provides a user-interface for collecting and storing, in a memory associated with and accessible by a computer platform, personal information about the golfer and data representative of the golfer's performance in at least one event associated with the simulator where data collection by the simulator and storage thereof is automated and occurs without the golfer's intervention.

19. The system of 18, further including a user-interface by which at least one spectator views the performance of the golfer.

20. The system of claim 18, further including the user-interface displaying to the golfer an advertisement, said advertisement stored in the associated memory, as a function of the golfer's performance data, and a data tagging application wherein a first level of revenue is collected as a result of the golfer acknowledging the displayed advertisement.
